(19) United States
(12) Patent Application Publication
(10) Pub. No.: US 2015/0075728 A1
(43) Pub. Date: Mar. 19, 2015

(54) HORIZONTAL BLIND AND METHOD FOR MANUFACTURING HORIZONTAL BLIND

(71) Applicant: TACHIKAWA CORPORATION, Tokyo (JP)

(72) Inventors: Koi Tachikawa, Tokyo (JP); Kazuto Yamagishi, Tokyo (JP); Yoshiyuki Hadano, Tokyo (JP); Tadashi Okamura, Tokyo (JP); Takenobu Ebato, Tokyo (JP)

(73) Assignee: TACHIKAWA CORPORATION, Tokyo (JP)

(21) Appl. No.: 14/389,661

(22) PCT Filed: Mar. 28, 2013
(86) PCT No.: PCT/JP2013/059302

§ 371 Date: Sep. 30, 2014

(30) Foreign Application Priority Data
Mar. 30, 2012 (JP) 2012-081858
Jun. 20, 2012 (JP) 2012-139255

(51) Int. Cl. E06B 9/303

(52) U.S. Cl. CPC E06B 9/303
USPC 160/168.1 R; 29/24.5

(57) ABSTRACT

A weft of each rung of a ladder cord is formed of two weft threads, an intersecting portion is formed in the weft threads, a slat is inserted between the intersecting portion and one of warp threads of the ladder cord, and a lifting and lowering cord is inserted between the weft threads at a location between the intersecting portion and another of the warp threads.

### TECHNICAL FIELD

The present invention relates to a horizontal blind, in which a number of rungs of slats are suspended from a head box via ladder cords, and to a method of manufacturing a horizontal blind.

### BACKGROUND

In a horizontal blind, a number of rungs of slats are supported by multiple ladder cords suspended from a head box, and all the slats can be operated to turn in the same phase through the ladder cords by operating a suspension apparatus for the ladder cords, which is disposed in the head box, with an operation apparatus.

A bottom rail is attached to lower ends of the ladder cords, and a lower end of a lifting/lowering cord suspended form the head box is attached to the bottom rail. Operating the operation apparatus causes a lifting/lowering apparatus disposed in the head box to lift or lower the lifting/lowering cord, which in turn lifts or lowers the bottom rail to lift or lower the slats.

In one type of such horizontal blinds, multiple lifting/lowering cords are suspended in front and back of the slats, without being inserted in the slats, for lifting or lowering the bottom rail.

In such a configuration, since it is not necessary to provide the slats with insertion holes for the lifting/lowering cords, no light leaks through the insertion holes.

Patent Document 1 discloses a horizontal blind in which lifting/lowering cords are not inserted in the slats, wherein each of the slats is inserted between weft threads of the ladder cords, the weft threads intersecting with each other, and a locking concavity of the slat is engaged with an intersecting portion of the weft threads so that misalignment of the slat in the longitudinal direction relative to the ladder cord is prevented.

Patent Document 2 discloses a horizontal blind in which a lifting/lowering cord is not inserted in the slats, wherein a lifting/lowering cord is inserted in a guide ring provided on the warp thread of a ladder cord. Further, it also discloses a configuration where two weft threads are supported in parallel to each other between warp threads and their positions in the vertical direction are interchanged to form intersecting portions at both sides of the weft threads, the slat is inserted between the intersecting portions, and the intersecting portions are engaged with notches of the slat so that misalignment of the slat in the longitudinal direction is prevented.

### PRIOR ART DOCUMENTS

### Patent Documents

Patent Document 1: Japanese Utility Model Application Publication No. H7-6477.
Patent Document 2: Japanese Unexamined Utility Model Application Publication No. S62-182398.

### SUMMARY OF THE INVENTION

### Problems to be Solved

Patent Document 1 does not disclose positional relationship of the lifting/lowering cord relative to the ladder cord. If the lifting/lowering cord is not held by the ladder cord, the slats are layered tortuously in the right and left direction, i.e., in the longitudinal direction, in a lifting operation of the slats, which is aesthetically undesirable.

If the lifting/lowering cord is inserted in the guide ring provided on the warp thread of the ladder cord, as disclosed in the Patent Document 2, the lifting/lowering cord is held only loosely by the warp thread so that slats are layered tortuously in the right and left direction. If the lifting/lowering cord is inserted between the weft threads, friction occurs between the lifting/lowering cord and the notch of the slat, which makes the lifting/lowering cord wear easily and an operation force required in the lifting or lowering operation greater.

In the configuration where positions of two weft threads are interchanged in the vertical direction to form intersecting portions at both sides of the weft threads and the slat is inserted between the intersecting portions, it is difficult to mechanize a work step for inserting the slat between the weft threads, so that manual work is required, entailing an increase in production cost.

An object of the present invention is to provide a horizontal blind in which lateral misalignment of slats relative to ladder cords and tortuous layering of the slats occurring in a lifting operation can be prevented, friction between a lifting/lowering cord and the slats can be prevented, and further, assembling is facilitated and shielding performance is enhanced.

### Means to Solve the Problems

According to claim 1, a horizontal blind is provided which comprises a head box; multiple ladder cords suspended from the head box, each of the ladder cords having two warp threads and a weft provided between the two warp threads at each rung thereof; slats each supported by the weft at each rung of the ladder cords; and multiple lifting/lowering cords suspended from the head box, the slats being configured so as to be capable of being turned through the intermediary of the ladder cords and capable of being lifted or lowered by lifting or lowering the lifting/lowering cords, wherein the weft at each rung of the ladder cords is formed of multiple pieces of weft threads, at least one intersecting portion is formed in the weft threads, the slat is inserted among the intersecting portion and the weft threads, and the lifting/lowering cord is inserted between the weft threads at a location between the intersecting portion and the warp thread.

In claim 2, the weft is formed of two weft threads which are formed on the warp threads in a state where they intersect with each other.

In claim 3, a notch that engages with the weft thread is provided in a side edge of the slat on a side where the lifting/lowering cord is arranged.

In claim 4, the following relationship exists: W+(A/2)≧S, where W denotes a distance between the two warp threads, A denotes a distance between the two weft threads, and S denotes a width of the slat.

In claim 5, the following relationship exists: H1+H2≦D, where D denotes a depth of the notch provided in one side edge of the slat, H1 denotes a thickness of the lifting/lowering cord, and H2 denotes a thickness of the weft thread.

In claim 6, the lifting/lowering cord inserted between the multiple pieces of weft threads at the location between the intersecting portion and the warp thread is inserted such that the multiple pieces of weft threads at the intersecting portion intersect with each other as seen from above.

In claim 7, the intersecting portion is formed so as to be one-sided to the notch of the slat.

In claim 8, the lifting/lowering cord is inserted between the weft threads every multiple rungs.

According to claim 9, a method of manufacturing a horizontal blind is provided, the method comprising the steps of: forming two weft threads that intersect with each other into a weft of each rung of a ladder cord; expanding a space between an intersecting portion of the weft threads and one of warp threads of the ladder cord by means of a jig and inserting a slat in the space; and inserting a lifting/lowering cord between the weft threads at a location between the intersecting portion of the weft threads and another of the warp threads of the ladder cord.

In claim 10, the jig is provided with multiple operation shafts corresponding one-to-one with the rungs of the ladder cord, each of the operation shafts expanding the space between the intersecting portion of the weft threads and the one of the warp threads of the ladder cord for inserting the slat in the space, and the space between the intersecting portion of the weft threads and the one of the warp threads of the ladder cord is expanded simultaneously for all rungs of the ladder cord by means of each of the operation shafts.

In claim 11, insertion of the lifting/lowering cord between the weft threads at the location between the intersecting portion of the weft threads and another of the warp threads of the ladder cord is performed such that the two weft threads intersect with each other as seen from above.

In claim 12, insertion of the lifting/lowering cord between the weft threads at the location between the intersecting portion of the weft threads and another of the warp threads of the ladder cord is performed such that the two weft threads do not intersect with each other as seen from above.

In claim 13, right-side and left-side ladder cords for supporting right and left sides of the slats, respectively, are so configured that intersecting portions that engage with notches of the slats intersect such that directions of overlap of the weft threads in right and left direction are different between the right-side and left-side ladder cords, and insertion of the lifting/lowering cords at both right and left sides between the weft threads at the location between the intersecting portion of the weft threads and another of the warp threads of the ladder cord is performed such that the two weft threads do not intersect with each other as seen from above.

According to claim 14, a method of manufacturing a horizontal blind is provided, wherein the intersecting portion is formed such that one of the weft threads is wound half or more around another of the weft threads and linked to the warp threads so that a state of intersection is not raveled.

### Advantageous Effect of the Invention

According to the present invention, a horizontal blind can be provided in which lateral misalignment of slats relative to ladder cords and tortuous layering of the slats in a lifting operation are prevented, friction between a lifting/lowering cord and the slats can be prevented, and further, assembling is facilitated and shielding performance is good.

### BRIEF DESCRIPTION OF THE DRAWINGS

FIG. 1 is a view explaining a first embodiment, where (a) is a perspective view showing a slat-supporting section of a horizontal blind; (b) is a view showing a state in which a lifting/lowering cord is inserted; and (c) is a plan view explaining a relationship among the lifting/lowering cord, first and second weft threads and a notch of a slat.

FIG. 2 is a plan view showing the slat-supporting section of the horizontal blind.

FIG. 3 is a front view showing a ladder cord.

FIG. 4 is a front view showing the ladder cord.

FIG. 5 is a front view showing the ladder cord in which the slat is inserted.

FIG. 6 is a front view showing the ladder cord in which the slat is inserted.

FIG. 7 is a front view showing an attaching process of the slat.

FIG. 8 is a front view showing the attaching process of the slat.

FIG. 9 is a front view showing the attaching process of the slat.

FIGS. 10 (a) and (b) are perspective views showing an attaching process of the slat to the ladder cord.

FIGS. 11 (a) and (b) are perspective views showing the attaching process of the slat to the ladder cord.

FIG. 12 (a) is a view showing an engagement state of a weft thread of the ladder cord and the notch when the slat is in a fully-closed state; (b) is a view showing an engagement state of a second weft thread of the ladder cord and the notch when the slat is in the fully-closed state; and (c) is a view showing an engagement state of the ladder cord and the notch when the slat is in the fully-closed state.

FIG. 13 (a) is a perspective view explaining a working of the lifting/lowering cord when the slat is in the fully-closed state; (b) is a perspective view explaining a working of the lifting/lowering cord when the slat is in a contrariwise fully-closed state; (c) is a side view explaining the working of the lifting/lowering cord when the slat is in the fully-closed state; and (d) is a side view explaining the working of the lifting/lowering cord when the slat is in the contrariwise fully-closed state.

FIG. 14 is a perspective view showing a second embodiment.

FIG. 15 is a view showing a third embodiment, where (a) is a side view explaining a relationship between first and second warp threads and first and second weft threads of the ladder cord; and (b) is a side view explaining a width of the slat.

FIG. 16 is a view explaining a fourth embodiment, where (a) is a perspective view of a principal part showing a state in which the slat is supported horizontally; and (b) is a perspective view of the principal part showing a state in which the slat is supported in the fully-closed state.

FIG. 17 is a view showing the slat and the ladder cord for explaining a fifth embodiment.

FIG. 18 is a view showing an intersecting state of the first and second weft threads of a left-side ladder cord.

FIG. 19 is a view showing an intersecting state of the first and second weft threads of a right-side ladder cord.

FIG. 20 (a) is a view showing an intersecting state of the first and second weft threads of the left-side ladder cord when the slat is in the fully-closed state; (b) is a view showing an intersecting state of the first and second weft threads of the right-side ladder cord when the slat is in the fully-closed state; and (c) and (d) are views showing a manner of inserting a left-side lifting/lowering cord.

FIG. 21 is a view explaining a sixth embodiment, where (a) is a perspective view explaining a working of the lifting/lowering cord when the slat is in the fully-closed state; (b) is a perspective view explaining a working of the lifting/lowering cord when the slat is in the contrariwise fully-closed state; (c) is a side view explaining the working of the lifting/lowering cord when the slat is in the fully-closed state; and (d) is a side view explaining the working of the lifting/lowering cord when the slat is in the contrariwise fully-closed state.

FIG. 22 is a view of a seventh embodiment, explaining a configuration where the slat is supported by four weft threads.

FIG. 23 is a view of another example of the seventh embodiment, explaining a configuration for supporting the slat.

FIGS. 24 (a) and (b) are views explaining the configuration for supporting the slat when one weft thread is cut.

FIG. 25 is a view of another example of the seventh embodiment, explaining a configuration for supporting the slat.

FIG. 26 is a view explaining a configuration for supporting the slat in another example.

FIG. 27 is a view explaining a configuration for supporting the slat by three weft threads in another example.

FIG. 28 is a view explaining a configuration for supporting the slat by three weft threads in another example.

FIG. 29 is a view explaining a manner of inserting the lifting/lowering cord in the seventh embodiment.

FIG. 30 is a view of an eighth embodiment, explaining a configuration of the weft threads for supporting the slat.

FIG. 31 is a view showing a state where the lifting/lowering cord is inserted.

FIG. 32 is a view showing the state where the lifting/lowering cord is inserted.

FIG. 33 is a view showing a state where the lifting/lowering cord is inserted in another example.

FIG. 34 is a view showing the state where the lifting/lowering cord is inserted in another example.

FIG. 35 is a view of another example of the eighth embodiment, explaining a configuration of the weft threads for supporting the slat.

FIG. 36 is a view showing a state where the lifting/lowering cord is inserted.

FIG. 37 is a view showing the state where the lifting/lowering cord is inserted.

FIG. 38 is a view of a ninth embodiment, explaining a configuration of the weft threads for supporting the slat.

FIG. 39 is a view showing a state where the lifting/lowering cord is inserted.

FIG. 40 is a view showing the state where the lifting/lowering cord is inserted.

FIG. 41 is a view of another example of the ninth embodiment, explaining a configuration of the weft threads for supporting the slat.

FIG. 42 is a view showing a state where the slat and the lifting/lowering cord are inserted.

FIG. 43 is a view of a tenth embodiment, explaining a configuration of the weft threads for supporting the slat.

FIG. 44 is a view showing a state where the lifting/lowering cord is inserted.

FIGS. 45 (a), (b) and (c) are views showing various states where the lifting/lowering cord is inserted.

FIG. 46 is a view of another example of the tenth embodiment, explaining a configuration of the weft threads for supporting the slat.

FIG. 47 is a view showing a state where the slat and the lifting/lowering cord are inserted.

FIG. 48 is a view showing another manner of inserting the lifting/lowering cord.

FIG. 49 is a view of an eleventh embodiment, explaining a configuration of the weft threads for supporting the slat.

FIG. 50 is a view showing a state where the lifting/lowering cord is inserted.

FIG. 51 is a view of another example of the eleventh embodiment, explaining a configuration of the weft threads for supporting the slat.

FIG. 52 is a view showing a state where the slat and the lifting/lowering cord are inserted.

FIG. 53 is a view showing a state of engagement of the first and second weft threads and the notch when the slat is in the contrariwise fully-closed state.

FIG. 54 is a front view of a horizontal blind, explaining a twelfth embodiment.

FIG. 55 is a perspective view of the ladder cords to which the slats and the lifting/lowering cords have been attached.

FIG. 56 is a view showing a state where the lifting/lowering cord is inserted in the ladder cord in which the slat has been inserted.

FIGS. 57 (a)-(c) are views showing supporting states of the slat.

FIG. 58 (a) is a view showing a state of the slat at both right and left positions when contrariwise fully closed; (b) is a view showing a state of the slat, having the notch, at a middle position when contrariwise fully closed; and (c) is a view showing a state of the slat, without a notch, at the middle position when contrariwise fully closed.

FIG. 59 (a) is a view showing a state of the slat at both right and left positions when fully closed; (b) is a view showing a state of the slat, having the notch, at a middle position when fully closed; and (c) is a view showing a state of the slat, without a notch, at the middle position when fully closed.

FIG. 60 is a perspective view of another example of the twelfth embodiment, showing the ladder cords to which the slats and the lifting/lowering cords have been attached.

FIGS. 61 (a), (b) and (c) are views explaining a method of forming a guide ring and the first and second weft threads

### BEST MODE FOR CARRYING OUT THE INVENTION

### First Embodiment

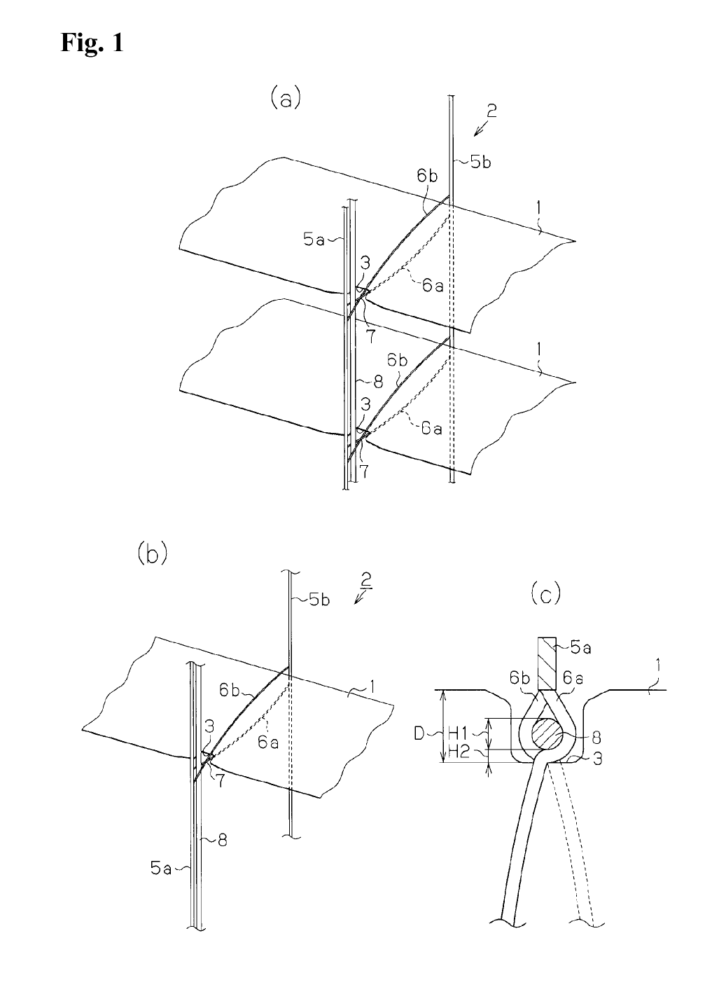

Hereafter a first embodiment substantiating the present invention will be described according to the drawings. As shown in FIG. 1, a slat 1 of a horizontal blind is formed of a thin plate of aluminum, and has a notch 3 formed in one side edge in the width direction at a location supported by a ladder cord 2. The notch 3 is formed into a generally rectangular shape, and both sides of an opening thereof are cut off at a tilt to form a guiding portion.

As for the ladder cord 2, at least two are suspended from a head box (not shown) in order to support the slats 1, and, in this embodiment, four ladder cords 2 are suspended. In a space surrounded by a warp thread 5a and weft threads 6a, 6b seen in the side view shown in FIG. 1 (a), which is an enclosed space (closed space) surrounded by the weft threads 6a, 6b seen also in the plan view of FIG. 1 (c), a lifting/lowering cord 8 is inserted.

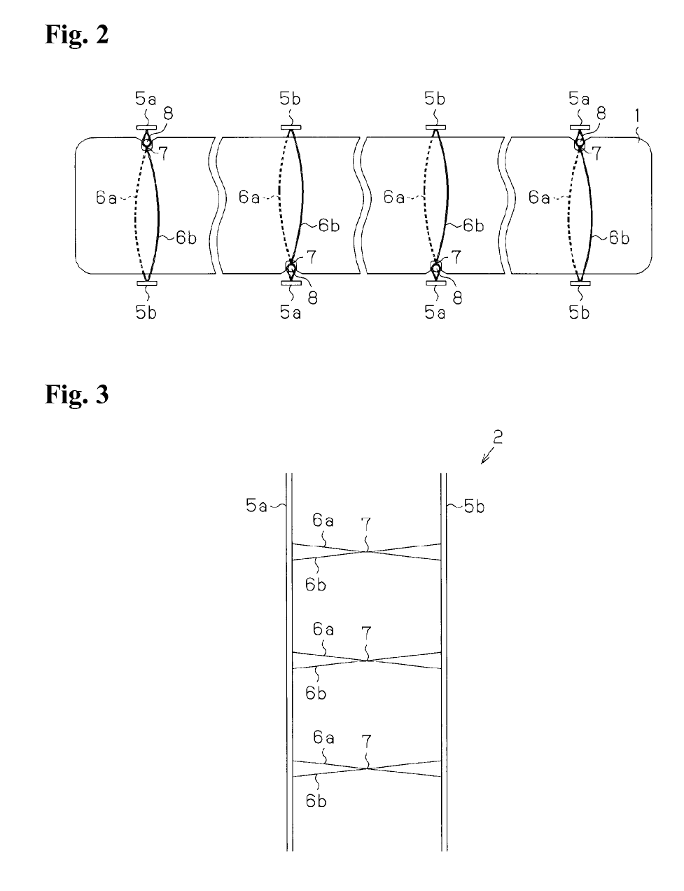

As shown in FIG. 2, the notch 3 is provided in each of the slats 1 at the location supported by the ladder cord 2.

The ladder cord 2 is provided with a pair of warp threads 5a, 5b and a number of vertical rungs of weft threads arranged between the warp threads 5a, 5b, each rung of the weft threads including two weft threads 6a, 6b for supporting one slat 1.

As shown in FIG. 3, the weft threads 6a, 6b are formed on the one warp thread 5a such that an end of the weft thread 6a is located above an end of the weft thread 6b, and on the other warp thread 5b such that an end of the weft thread 6b is located above an end of the weft thread 6a. Thus, the weft threads 6a, 6b is provided with an intersecting portion 7 where they intersect with each other midway therein.

The slat 1 is inserted between the intersecting portion 7 and the other warp thread 5b such that the intersecting portion 7 of the weft threads 6a, 6b is located within the notch 3.

As shown in FIGS. 1 and 2, the lifting/lowering cord 8, which is for lifting and lowering the slat 1, is inserted between the weft threads 6a, 6b at a location between the intersecting portion 7 located within the notch 3 and the one warp thread 5a. Therefore, at both sides in the longitudinal direction of the slat 1, the lifting/lowering cords 8 are on a side of the slat 1 oriented to the interior of the room, for example, while at middle positions in the longitudinal direction of the slat 1, the lifting/lowering cords 8 are on a side of the slat 1 oriented to the exterior of the room, and a bottom rail is attached to the lower end of each of the lifting/lowering cords 8.

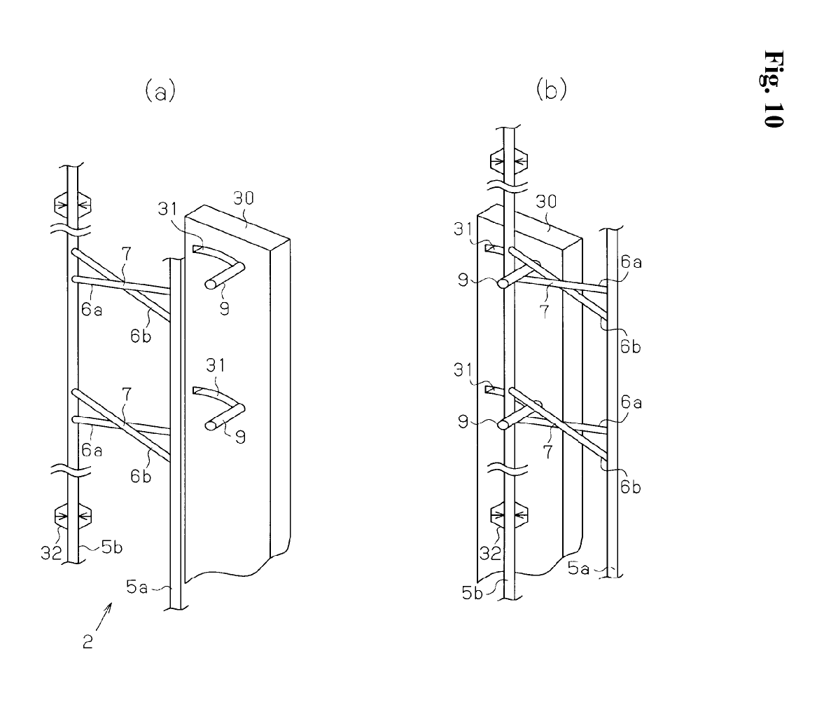

In combining the slats 1 and the lifting/lowering cords 8 with the ladder cords 2 configured as described above, as shown in FIG. 7, an operation shaft 9 of a thin rod shape is inserted between the intersecting portion 7 of the weft threads 6a, 6b and the warp thread 5b of the ladder cord 2. Then, as shown in FIG. 8, the operation shaft 9 is slid toward the warp thread 5a to secure a space enabling insertion of the slat 1 between the intersecting portion 7 and the warp thread 5b.

Next, as shown in FIG. 9, the slat 1 is inserted between the weft threads 6a, 6b at the location between the intersecting portion 7 and the warp thread 5b.

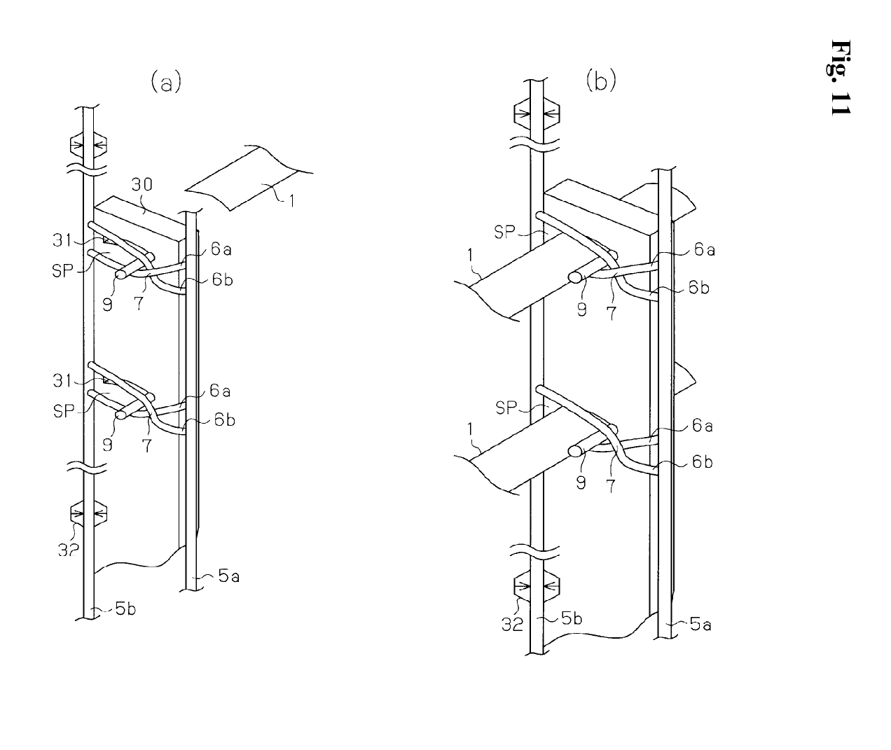

In more detail, as shown in FIG. 10 (a), a jig 30 is used for inserting the slat 1 between the intersecting portion 7 of the weft threads 6a, 6b and the one warp thread 5b. The jig 30 is provided with insertion holes 31 which are configured such that not only a number of the operation shafts 9 protrude therethrough at regular intervals so as to be capable of being inserted between the weft threads 6a, 6b of each rung, but also the slats 1 are inserted therethrough.

While the one warp thread 5b of the ladder cord 2 is held by a holding apparatus 32, the operation shafts 9 are each inserted between the weft threads 6a, 6b, as shown in FIG. 10 (b).

Next, as shown in FIG. 11 (a), the jig 30 is shifted toward the warp thread 5a, causing the intersecting portion 7 to be shifted by the operation shaft 9 toward the warp thread 5a, and thus making the distance between the intersecting portion 7 and the warp thread 5b greater than the width of the slat 1, which results in formation of a slat-inserting space SP.

Next, as shown in FIG. 11 (b), the slat 1 is inserted through the insertion hole 31 of the jig 30, and, as a result, the slat 1 is inserted in the slat-inserting space SP. Thereafter, the jig 30 is detached from the ladder cord 2, and thus, the insertion process of the slat 1 into the ladder cord 2 using the jig 30 is completed.

Next, as shown in FIG. 5, the operation shaft 9 between the weft threads 6a, 6b is pulled out. Then, the lifting/lowering cord 8 is inserted in the space surrounded by the intersecting portion 7, the warp thread 5a and the weft threads 6a, 6b. Thus, the combining process of the slats 1 and the lifting/lowering cords 8 with the ladder cords 2 is completed.

Thereafter, the upper ends of the warp threads 5a, 5b of the ladder cord 2 are attached to a ladder cord-supporting apparatus within the head box, and the lower ends of the warp threads 5a, 5b of the ladder cord 2 are attached to the bottom rail. Then, the upper end of the lifting/lowering cord 8 is attached to a lifting/lowering apparatus within the head box and the lower end of the lifting/lowering cord 8 is attached to the bottom rail. It is possible to insert the slat 1, unlike the Patent Document 1, without expanding a gap between the intersecting portion and the warp thread by means of an end portion of the slat.

Next, the working of the horizontal blind having the above configuration will be described. When the lifting/lowering cord 8 suspended from the head box is lifted by an operation of an operation apparatus, the bottom rail is lifted so that the slats 1 are lifted in a state where the slats 1 are layered sequentially, with the slat of the lowermost rung first, on the bottom rail.

Also, when the lifting/lowering cord 8 is lowered by an operation of the operation apparatus, the bottom rail is lowered so that the slats 1 are restored sequentially, with the slat of the uppermost rung first, to a state where they are supported by the ladder cord 2.

When one of the warp threads of the ladder cord 2 is lifted by an operation of the operation apparatus through the ladder cord-supporting apparatus, the slats 1 are turned in a direction leading to a fully-closed state or in a direction leading to a contrariwise fully-closed state.

In such a lifting or lowering operation of the slats 1, lateral misalignment of the slats 1, i.e., misalignment of the slats 1 in position in the longitudinal direction, is blocked, since the intersecting portions 7 of the weft threads 6a, 6b are in engagement with the notches 3 of the slats 1.

The weft threads 6a, 6b and the intersecting portion 7 are interposed between the lifting/lowering cord 8 and an edge of the notch 3, so that the lifting/lowering cord 8 does not touch the edge of the notch 3 directly. Therefore, increase in the operation force due to friction between the lifting/lowering cord 8 and the edge is prevented, and further, wear of the lifting/lowering cord 8 resulting from repeated operations for lifting or lowering the slats is suppressed.

Moreover, since the lifting/lowering cord 8 is inserted in the space surrounded by the weft threads 6a, 6b, the intersecting portion 7 and the warp thread 5a, fluctuation in the suspending position of the ladder cord 2 is restricted by the lifting/lowering cord 8, and thus, it is possible to prevent tortuous layering of the slats 1 on the bottom rail from occurring in the lifting operation of the slats 1.

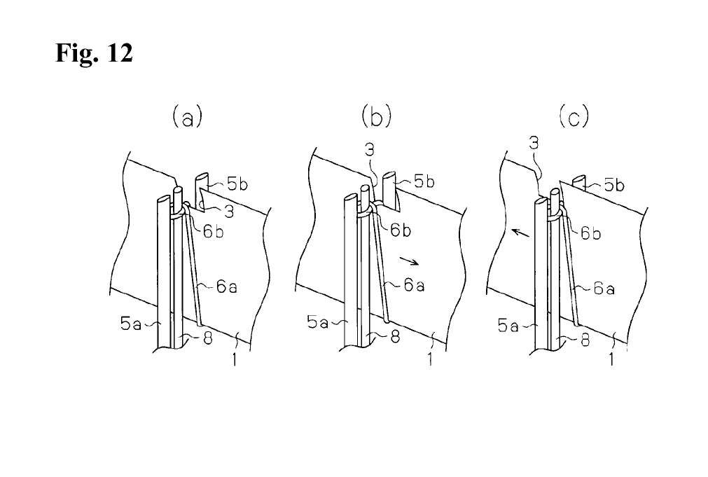

Furthermore, as shown in FIGS. 12 (a)-(c), the lifting/lowering cord 8 is inserted in the space formed by the weft thread 6a, the weft thread 6b and the warp thread 5a, the space being between the warp thread 5a and the intersecting portion 7 at which the weft thread 6a intersects with the weft thread 6b from the right side. Here, the lifting/lowering cord 8 is inserted such that the weft thread 6a is disposed on the right side and the weft thread 6b is disposed on the left side as seen from above.

Due to this arrangement, even if the slat 1 is urged to move in the direction indicated by the arrow in FIG. 12 (b), lateral misalignment of the slat 1 in the direction shown by the arrow is restricted by the weft thread 6b. In contrast, even if the slat 1 is urged to move in the direction indicated by the arrow in FIG. 12 (c), lateral misalignment of the slat 1 in the direction shown by the arrow is restricted by the lifting/lowering cord 8.

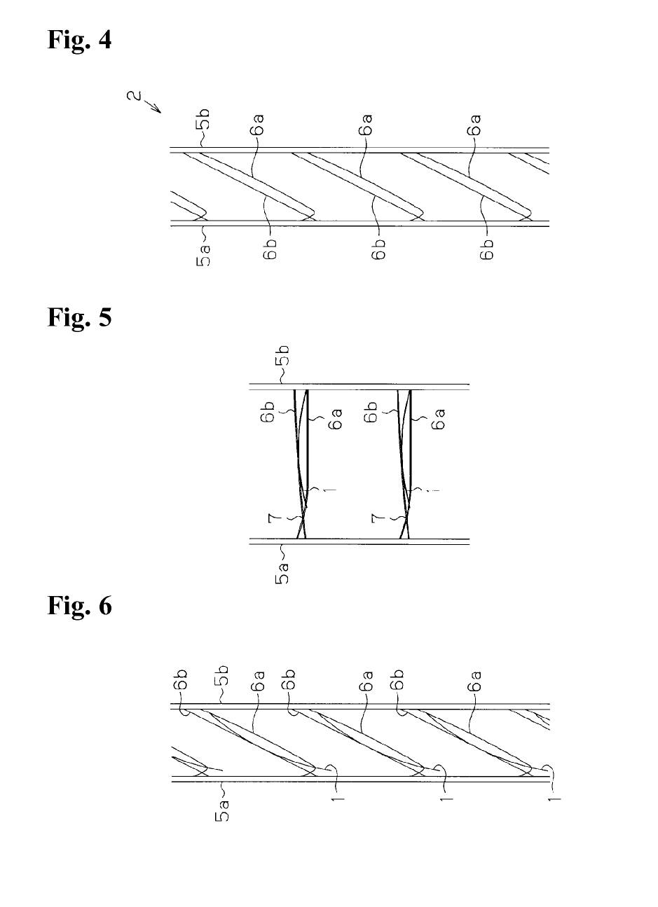

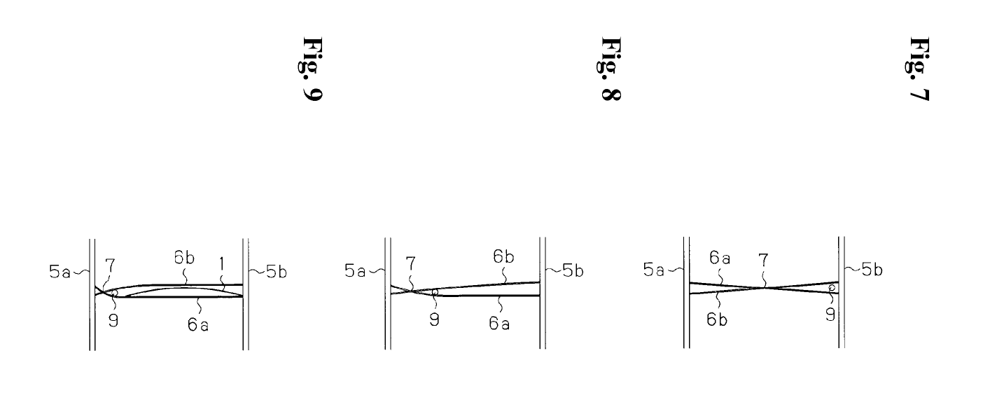

As shown in FIG. 4, when the warp thread 5b is moved upward and the warp thread 5a is moved downward in a turning operation of the slat 1, though the weft thread 6a located on a side of the lower surface of the slat 1 is loosened a little, the weft thread 6b located on a side of the upper surface of the slat 1 is tightened. As a result, as shown in FIG. 6, the upper surface of the slat 1 is pressed by the weft thread 6b in the turning operation of the slat 1, so that the slat 1 is turned certainly into the fully-closed state in which the slat is in the vertical direction, i.e., the convex surface thereof is oriented to the exterior of the room.

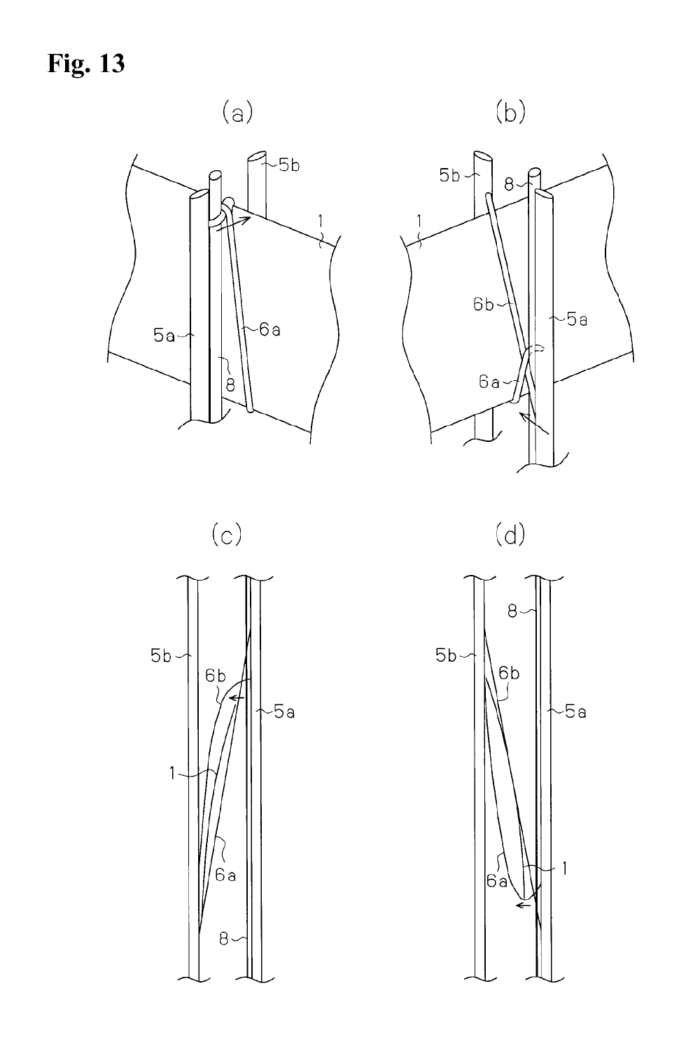

At this time, since the lifting/lowering cord 8 is disposed inside of the warp threads 5a, 5b, a pressing force is applied to the slat 1 in the direction indicated by the arrows in FIGS. 13 (a) and 13 (c) through the weft threads 6a, 6b intersecting with each other as seen from above, which has an effect of increasing shielding performance in the fully-closed state.

Further, also in the contrariwise fully-closed state, a pressing force is applied to the slat 1 in the direction indicated by the arrows in FIGS. 13 (b) and 13 (d) through the weft threads 6a, 6b intersecting with each other as seen from above, which has an effect of increasing shielding performance in the contrariwise fully-closed state.

Note that the notch is omitted in FIGS. 13 (a) and 13 (b) as a matter of convenience for explanation.

According to the horizontal blind configured as described above, the following effects can be obtained.

(1) Since the intersecting portion 7 of the weft threads 6a, 6b is in engagement with the notch 3 of the slat 1, it is possible to bock misalignment of the slat 1 in position in the longitudinal direction. Especially, even in the case where the slat 1 is turned such that the notch 3 is at the upper edge thereof, misalignment does not occur, since engagement of the intersecting portion 7 with the notch 3 is facilitated.

(2) Since the slat 1 is inserted between the weft threads 6a, 6b at the location between the intersecting portion 7 of the weft threads 6a, 6b and the warp thread 5b and the lifting/lowering cord 8 is inserted between the weft threads 6a, 6b at the location between the intersecting portion 7 and the warp thread 5a, it is possible to prevent tortuous layering of the slats 1 on the bottom rail, in the right and left direction, i.e., the longitudinal direction, from occurring in the lifting operation of the slats.

(3) Since the weft threads 6a, 6b are interposed between the lifting/lowering cord 8 and the edge of the notch 3, it is possible to suppress wear of the lifting/lowering cord 8 and to reduce the operation force required in the lifting or lowering operation.

(4) In the turning operation of the slat 1, the weft thread 6b touching the upper surface of the slat 1 is tightened and the weft thread 6a supporting the lower surface of the slat 1 is loosened, so that the slat 1 can be turned easily into a substantially vertical direction when setting the slat 1 in the fully-closed state. Therefore, it is possible to enhance light-shielding performance when the slat is in the fully-closed state.

(5) The slat 1 can be inserted while the distance between the intersecting portion 7 of the weft threads 6a, 6b and the warp thread 5b is expanded by the operation shaft 9, so that it is possible to mechanize the insertion process of the slat 1 in the ladder cord 2, and thus, production cost is lowered.

The first embodiment described above may be implemented in the following manner.
In the first embodiment, it is not necessary to insert the lifting/lowering cord 8 between the weft threads 6a, 6b in all of the rungs among a number of rungs of the weft threads 6a, 6b, but the lifting/lowering cord 8 may be inserted, for example, at only one rung among five rungs of the weft threads 6a, 6b which are successive in the vertical direction.
In the first embodiment, the lifting/lowering cord may be suspended only either in front or in back of the slats, and the bottom rail may be attached to the lower end of that lifting/lowering cord.

### Second Embodiment

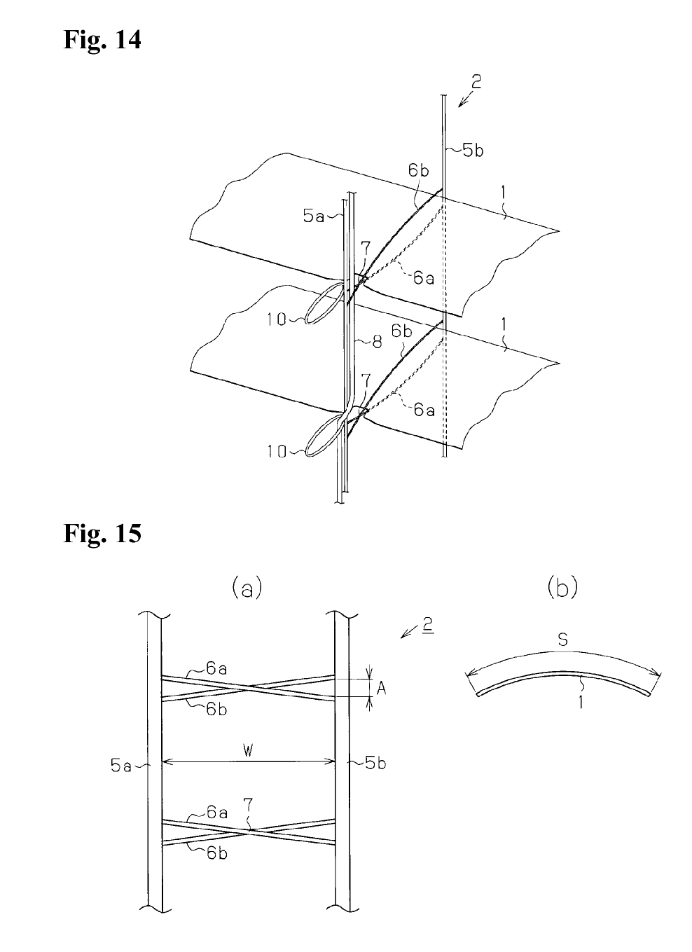

FIG. 14 shows a second embodiment. In this embodiment, the warp thread 5a of the ladder cord 2 is provided with guide rings 10 in the vicinities of attachment positions of the weft threads 6a, 6b. The lifting/lowering cord 8 is inserted alternately between the intersecting portion 7 of the weft threads 6a, 6b and the warp thread 5a and in the guide ring 10, every other pitch of the weft threads 6a, 6b.

According to the horizontal blind of this embodiment, the following effect can be obtained in addition to those obtained in the first embodiment.

Since the lifting/lowering cord 8 is inserted in the guide ring 10 every other pitch of the weft threads 6a, 6b, friction between the lifting/lowering cord 8 and the weft threads 6a, 6b can be reduced. Therefore, the operation force required in the operation for lifting or lowering the slats 1 is further reduced compared to the first embodiment.

The second embodiment described above may be implemented in the following manner.
In the second embodiment, it is not necessary to insert the lifting/lowering cord 8 between the weft threads 6a, 6b in all of the rungs among a number of rungs of the weft threads 6a, 6b, but the lifting/lowering cord 8 may be inserted, for example, at only one rung among five rungs of the weft threads 6a, 6b which are successive in the vertical direction.
While, in the second embodiment, the lifting/lowering cord 8 is inserted alternately in the guide ring 10 and between the intersecting portion 7 of the weft threads 6a, 6b and the warp thread 5a, inserting the lifting/lowering cord 8 between the intersecting portion 7 of the weft threads 6a, 6b and the warp thread 5a every three or four pitches will further reduce the friction between the lifting/lowering cord 8 and the weft threads 6a, 6b.
In the second embodiment, the lifting/lowering cord may be suspended only either in front or in back of the slats, and the bottom rail may be attached to the lower end of that lifting/lowering cord.

### Third Embodiment

FIG. 15 shows a third embodiment. In this embodiment, the distance between the weft threads 6a, 6b as well as the distance between the warp threads 5a, 5b of the ladder cord 2 shown in the first embodiment are specified in relation to the width of the slat 1.

As shown in FIG. 15 (a), in the ladder cord 2, a first weft thread 6a is formed on a first warp thread 5a so as to be located above a second weft thread 6b. Further, the second weft thread 6b is formed on a second warp thread 5b so as to be located above the first weft thread 6a.

In this situation, the distance between the first weft thread 6a and the second weft thread 6b in the vertical direction is defined as distance A.

Also, as shown in the figure, the distance between the first warp thread 5a and the second warp thread 5b is defined as distance W, and the width (length in the lateral direction) of the slat 1 is defined as S, as shown in FIG. 15 (b), and they are set such that the following relationship exists:

W+(A/2)≧S.

Due to this relationship, it is possible to slide the intersecting portion 7 toward the first warp thread 5a by means of the operation shaft 9 for inserting the slat 1 (see FIG. 5), securing a space between the intersecting portion 7 and the second warp thread 5b, in which space the slat 1 can be inserted. As a result, it is possible to insert the slat 1 easily between the first and second weft threads 6a, 6b at the location between the intersecting portion 7 and the second warp thread 5b.

Further, as shown in FIGS. 1 (a) and 1 (b), the intersecting portion 7 of the first and second weft threads 6a, 6b is engaged with the notch 3 of the slat 1. At the location between that intersecting portion 7 and the second warp thread 5b, the slat 1 is inserted between the first and second weft threads 6a, 6b, and at the location between that intersecting portion 7 and the first warp thread 5a, the lifting/lowering cord 8 is inserted in the space between the first and second weft threads 6a, 6b.

As shown in FIG. 1 (c), similarly to the first embodiment, the notch 3 is formed into a generally rectangular shape, and the depth D of the notch 3, which has guide portions formed at both sides of an opening thereof, is set in this embodiment such that the following relationship exists:

H1+H2≦D

where H1 is a thickness of the lifting/lowering cord 8 and H2 is a thickness of the first and second weft threads 6a, 6b.

Due to this relationship, it is possible to interpose the lifting/lowering cord 8 and the intersecting portion 7 within the notch 3, making it possible to more certainly prevent tortuous layering of the slats 1 on the bottom rail, in the right and left direction, i.e., the longitudinal direction, from occurring in the lifting operation of the slats.

Thus, in this embodiment, the following effects can be obtained, in addition to those of the first embodiment: it is possible to insert the slat 1 certainly in the space formed between the first and second weft threads 6a, 6b at the location between the intersecting portion 7 and the second warp thread 5b, and to prevent tortuous layering of the slats 1 in the longitudinal direction in the lifting operation of the slats.

### Fourth Embodiment

FIGS. 16 (a) and 16 (b) show a fourth embodiment.

As shown in FIG. 16 (a), in the ladder cords 2 at both right and left sides, the end of the first weft thread 6a is formed on the first warp thread 5a so as to be located above the end of the second weft thread 6b, and the end of the second weft thread 6b is formed on the second warp thread 5b opposite to the first warp thread 5a so as to be located above the end of the first weft thread 6a. Thus, at the location between the first warp thread 5a and the second warp thread 5b, the intersecting portion 7 is formed where the first weft thread 6a and the second weft thread 6b intersect with each other.

In this embodiment, the intersecting portion 7 supports the slat 1 by the first and second weft threads 6a, 6b, as shown in FIGS. 16 (a) and 16 (b). The intersecting portion 7 of the ladder cord 2 is one-sided to the first warp thread 5a. This one-sided positioning is achieved by locating the intersecting portion 7 closer to the first warp thread 5a through heat-setting at the time of manufacturing the ladder cord 2.

With respect to the ladder cord 2 thus manufactured, the slat 1 is placed on the first weft thread 6a and the second weft thread 6b whose intersecting portion 7 is one-sided to the first warp thread 5a, at the location between the first warp thread 5a and the second warp thread 5b.

Further, the lifting/lowering cord 8 is inserted in a space formed between the first weft thread 6a and the second weft thread 6b at the location between the first warp thread 5a and the one-sided intersecting portion 7, at the location of the notch 3.

Therefore, both right and left sides of the slat 1 is disposed on the first weft thread 6a and the second weft thread 6b intersecting with each other. Further, when the slat 1 is in a horizontal attitude, the intersecting portion 7 is located closer to the first warp thread 5a as shown in FIG. 16 (a), and when fully closed, the intersecting portion 7 is located closer to the notch 3 as shown in FIG. 16 (b).

Note that, as to the supporting structure for the slat thus configured, it is preferable that, in a horizontal blind composed of multiple rungs of slats, a predetermined number of upper slats or less are implemented by the supporting structure of this embodiment.

As described above, also in this embodiment, it is possible to block misalignment of the slat 1 in position in the longitudinal direction, and to prevent tortuous layering of the slats 1 in the longitudinal direction in the lifting operation of the slats. Further, since the first and the second weft threads 6a, 6b are interposed between the lifting/lowering cord 8 and the edge of the notch 3, it is possible to suppress wear of the lifting/lowering cord 8, and to reduce the operation force required in the lifting or lowering operation.

### Fifth Embodiment

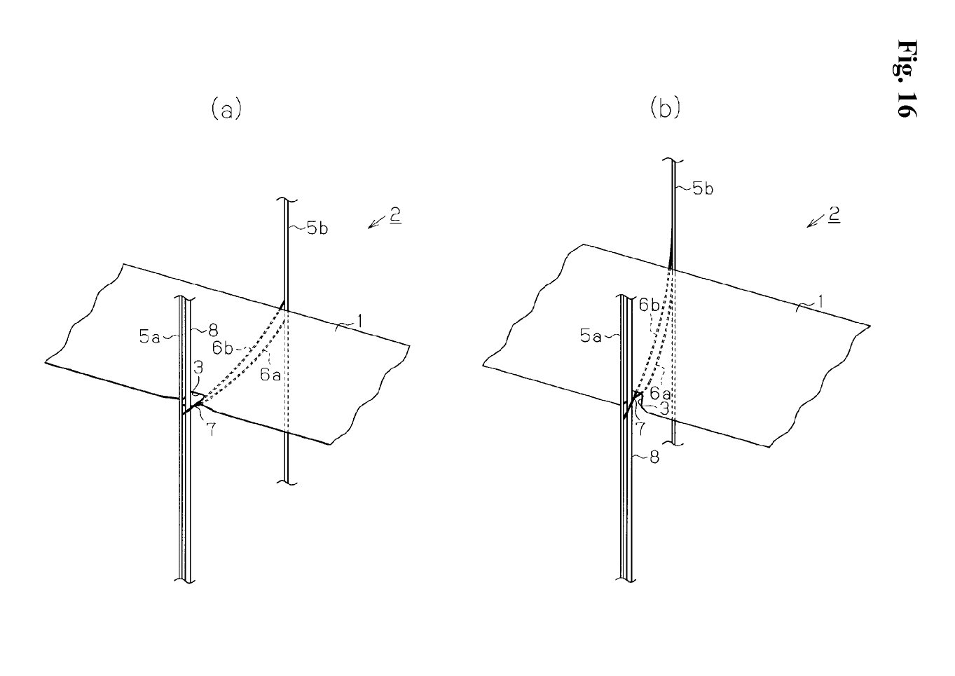

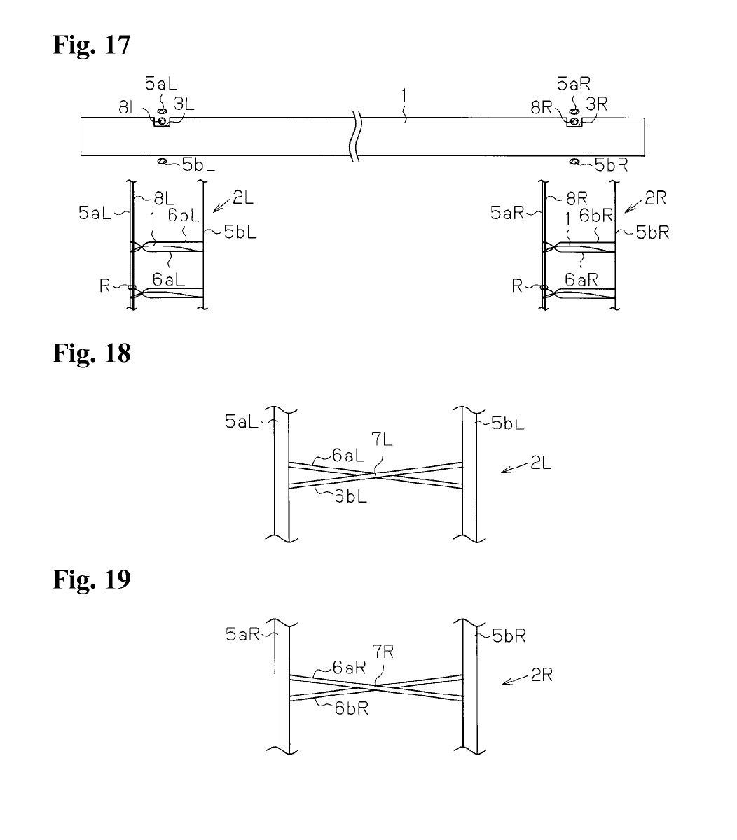

FIGS. 17 to 20 show a fifth embodiment.

FIG. 17 is a view explaining a relationship between the slats 1 and the ladder cords 2 provided on the right and left sides of the slats 1 and the lifting/lowering cords 8 provided on the right and left sides.

As shown in FIG. 17, the left side of the slat 1 is supported by a left-side ladder cord 2L, and the right side of the slat 1 is supported by a right-side ladder cord 2R. The slat 1 is provided, at both the right and left sides of one side edge, with a left-side notch 3L formed in the width direction at a location supported by the left-side ladder cord 2L, and with a right-side notch 3R formed in the width direction at a location supported by the right-side ladder cord 2R.

As shown in FIG. 18, on a left-side first warp thread 5aL of the left-side ladder cord 2L, an end of a left-side first weft thread 6aL is formed so as to be located above an end of a left-side second weft thread 6bL. Also, on a left-side second warp thread 5bL, an end of a left-side second weft thread 6bL is formed so as to be located above an end of a left-side first weft thread 6aL. That is, the left-side first and left-side second weft threads 6aL, 6bL are formed between the left-side first warp thread 5aL and the left-side second warp thread 5bL so as to intersect with each other.

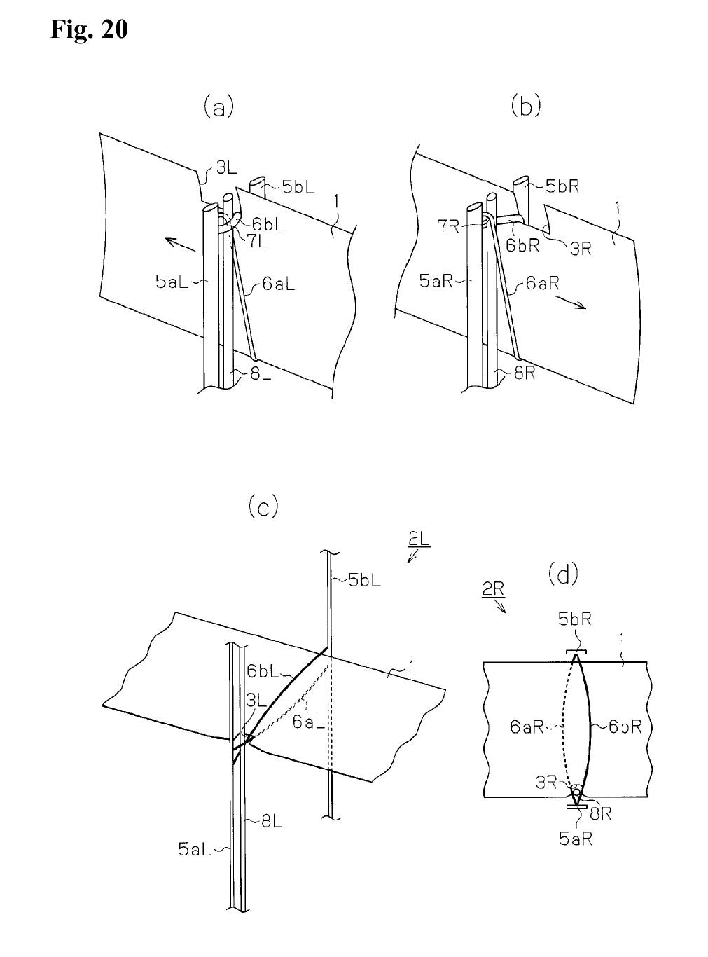

Here, as shown in FIGS. 20 (a), 20 (c) and 20 (d), the left-side first and left-side second weft threads 6aL, 6bL intersecting with each other are arranged such that, at a left-side intersecting portion 7L thereof, the left-side first weft thread 6aL is located on a left side of the left-side second weft thread 6bL as seen in FIG. 20 (a).

Meanwhile, as shown in FIG. 19, on a right-side first warp thread 5aR of the right-side ladder cord 2R, an end of a right-side first weft thread 6aR is formed so as to be located above an end of a right-side second weft thread 6bR. Also, on a right-side second warp thread 5bR, an end of a right-side second weft thread 6bR is formed so as to be located above an end of a right-side first weft thread 6aR. That is, the right-side first and right-side second weft threads 6aR, 6bR are formed between the right-side first warp thread 5aR and the right-side second warp thread 5bR so as to intersect with each other.

Here, the right-side first and right-side second weft threads 6aR, 6bR are arranged to intersect with each other, unlike in the left-side ladder cord 2L, such that, at a right-side intersecting portion 7R thereof, the right-side first weft thread 6aR is located on a right side of the right-side second weft thread 6bR as seen in FIG. 20 (b).

That is, as shown in FIGS. 20 (a) and 20 (b), in the left-side ladder cord 2L, the left-side first weft thread 6aL intersects with the left-side second weft thread 6bL while passing on the left side of the second weft thread 6bL, while, in the right-side ladder cord 2R, the right-side first weft thread 6aR intersects with the right-side second weft thread 6bR while passing on the right side of the second weft thread 6bR, as seen in FIG. 20 (b).

The slat 1 is inserted between the left-side and right-side first weft threads 6aL, 6aR and the left-side and right-side second weft threads 6bL, 6bR such that the left-side intersecting portion 7L is located in the left-side notch 3L and the right-side intersecting portion 7R is located in the right-side notch 3R.

Further, as shown in FIG. 18, the left-side lifting/lowering cord 8L is inserted in a space formed between the left-side first weft thread 6aL and the left-side second weft thread 6bL at a location between the left-side intersecting portion 7L located in the left-side notch 3L and the left-side first warp thread 5aL. That is, as shown in FIGS. 20 (a) and 20 (c), the lifting/lowering cord 8L disposed inside the warp threads 5aL, 5bL is in a state where the weft threads 6aL, 6bL do not intersect as seen from above. Also, as shown in FIG. 19, the right-side lifting/lowering cord 8R is inserted in a space formed between the right-side first weft thread 6aR and the right-side second weft thread 6bR at a location between the right-side intersecting portion 7R located in the right-side notch 3R and the right-side first warp thread 5aR. That is, as shown in FIGS. 20 (b) and 20 (d), the lifting/lowering cord 8R disposed inside the warp threads 5aR, 5bR is in a state where the weft threads 6aR, 6bR do not intersect as seen from above.

Due to the above configuration, this embodiment has the following effects.

Since, in the left-side ladder cord 2L, the left-side first weft thread 6aL is configured to intersect with the left-side second weft thread 6bL on the left side of the second weft thread 6bL, even if the slat 1 is urged to move leftward as shown in FIG. 20 (a), the left-side second weft thread 6bL engages with the left-side notch 3L and this state is maintained by the lifting/lowering cord 8L, which makes it possible to restrict the lateral misalignment of the slat 1 in the leftward direction.

On the other hand, in the right-side ladder cord 2R, the right-side first weft thread 6aR is configured to intersect with the right-side second weft thread 6bR on the right side of the second weft thread 6bR, even if the slat 1 is urged to move rightward as shown in FIG. 20 (b), the right-side second weft thread 6bR engages with the right-side notch 3R and this state is maintained by the lifting/lowering cord 8R, which makes it possible to restrict the lateral misalignment of the slat 1 in the rightward direction.

### Sixth Embodiment

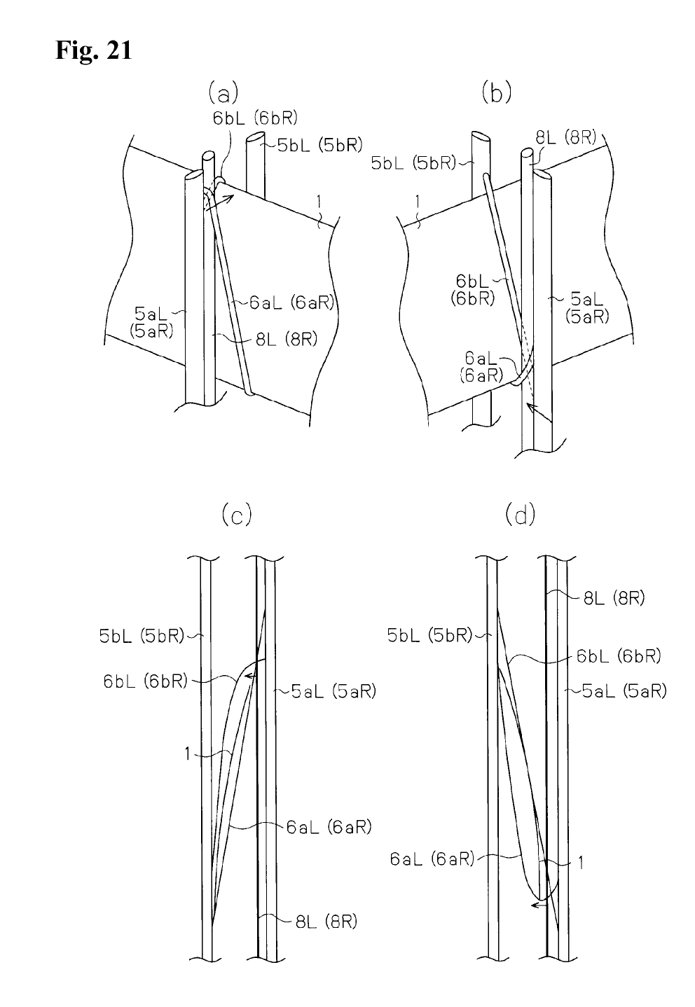

FIG. 21 shows a sixth embodiment.

The lifting/lowering cords 8L, 8R are disposed inside the warp threads 5aL, 5bL and 5aR, 5bR, respectively. A force is applied that presses the slat 1 directly in the direction indicated by the arrows in FIGS. 21 (a) and 21 (c) even though the weft threads 6aL, 6bL, 6aR, 6bR do not intersect as seen from above, and thus, an effect of enhanced shielding performance in the fully-closed state is obtained.

Further, also in the contrariwise fully-closed state, a force is applied that presses the slat 1 directly in the direction indicated by the arrows in FIGS. 21 (b) and 21 (d) even though the weft threads 6aL, 6bL, 6aR, 6bR do not intersect as seen from above, and thus, an effect of enhanced shielding performance in the contrariwise fully-closed state is obtained.

### Seventh Embodiment

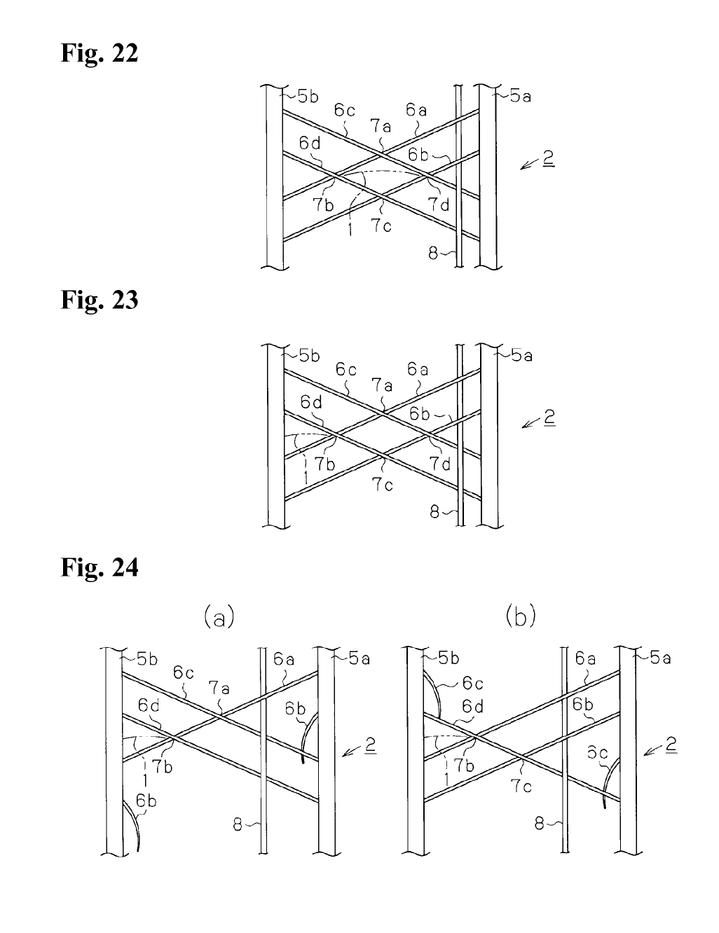

FIG. 22 shows a seventh embodiment.

As shown in FIG. 22, four weft threads, i.e., first to fourth weft threads 6a-6d, are formed between the first warp thread 5a and the second warp thread 5b. These four (first to fourth) weft threads 6a-6d are provided as one group at regular intervals in the vertical direction between the first warp thread 5a and the second warp thread 5b (only one group is shown in FIG. 22).

The first and second weft threads 6a, 6b are formed in parallel with each other between the first warp thread 5a and the second warp thread 5b in a state where the first weft thread 6a is located above the second weft thread 6b. Also, the third and fourth weft threads 6c, 6d are formed in parallel to each other between the first warp thread 5a and the second warp thread 5b in a state where the third weft thread 6c is located above the fourth weft thread 6d.

Further, as shown in FIG. 22, in the ladder cord 2, ends of the first and second weft threads 6a, 6b are formed on the first warp thread 5a so as to be located above ends of the third and fourth weft threads 6c, 6d. On the other hand, ends of the third and fourth weft threads 6c, 6d are formed on the second warp thread 5b so as to be located above ends of the first and second weft threads 6a, 6b.

Therefore, the first weft thread 6a and the third weft thread 6c intersect with each other at an intermediary location thereof, and a first intersecting portion 7a is formed as a result of the intersection.

Further, the first weft thread 6a and the fourth weft thread 6d intersect with each other at a location which is on a side of the first intersecting portion 7a closer to the second warp thread 5b and is below the first intersecting portion 7a, and a second intersecting portion 7b is formed as a result of the intersection.

Moreover, the second weft thread 6b and the fourth weft thread 6d intersect with each other at an intermediary location thereof and below the first intersecting portion 7a, and a third intersecting portion 7c is formed as a result of the intersection.

Furthermore, the second weft thread 6b and the third weft thread 6c intersect with each other at a location which is on a side of the first intersecting portion 7a closer to the first warp thread 5a and is below the first intersecting portion 7a, and a fourth intersecting portion 7d is formed as a result of the intersection.

These four (first to fourth) intersecting portions 7a-7d form a rhombus in a side view. The slat 1 is inserted in a space of the rhombic shape surrounded by the first to fourth intersecting portions 7a-7d. Here, the slat 1 is inserted such that the fourth intersecting portion 7d is located in the notch 3.

As shown in FIG. 22, the lifting/lowering cord 8 is inserted in a space formed by the second weft thread 6b, the third weft thread 6c and the first warp thread 5a on a side of the first warp thread 5a.

Here, as shown in FIG. 22, the lifting/lowering cord 8 is inserted in the space from a side of the first and second weft threads 6a, 6b, that is, the opposite side of the third and fourth weft threads 6c, 6d, and lead out to the side of the third and fourth weft threads 6c, 6d, that is, the opposite side of the first and second weft threads 6a, 6b. This results in formation of a closed space from which the lifting/lowering cord does not go into the space for inserting the slat.

Accordingly, in this embodiment, the lifting/lowering cord 8 is disposed between the second weft thread 6b and the third weft thread 6c, so that friction between the lifting/lowering cord 8 and the edge of the slat 1 is prevented. Further, since the slat 1 is engaged with and supported by the fourth intersecting portion 7d and the second intersecting portion 7b, the slat 1 is arranged symmetrically in the front-back direction, which makes shielding performance even on the front side and the back side.

Note that, in this embodiment, the slat 1 is inserted in the space of the rhombic shape surrounded by the first to fourth intersecting portions 7a-7d.

This may be implemented such that, as shown in FIG. 23, on the side of the second warp thread 5b, the slat 1 is inserted in a space formed by the first weft thread 6a, the fourth weft thread 6d and the second warp thread 5b. Here, the slat 1 is inserted so as to be located between the second intersecting portion 7b and the warp thread 5b.

According to this configuration, since two (the second and fourth) intersecting portions 7b, 7d are interposed on the side of the lifting/lowering cord 8 closer to the slat 1, and the lifting/lowering cord 8 is disposed between the two (first and second) weft threads 6a, 6b and the two (third and fourth) weft threads 6c, 6d, friction between the lifting/lowering cord 8 and the slat 1 is prevented, and enhanced durability can be achieved.

Further, for example, even if the second weft thread 6b is cut as shown in FIG. 24 (a) or the third weft thread 6c is cut as shown in FIG. 24 (b), the slat 1 remains disposed in the space formed by the first weft thread 6a, the fourth weft thread 6d and the second warp thread 5b, and the notch 3 exists at the second intersecting portion 7b, so that the slat 1 is still usable.

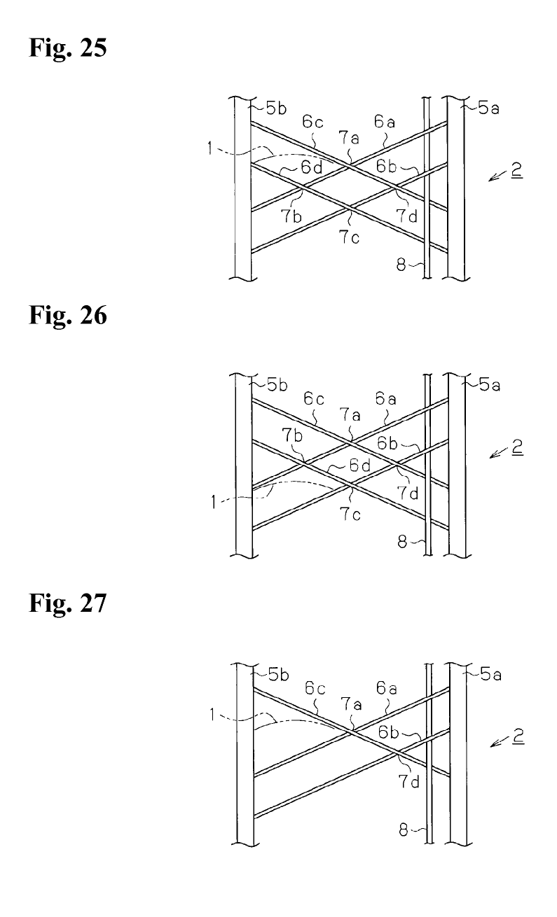

Similarly, the above embodiment may be implemented such that, as shown in FIG. 25, on the side of the second warp thread 5b, the slat 1 is inserted in a space formed by the first weft thread 6a, the third weft thread 6c, the fourth weft thread 6d and the second warp thread 5b. Here, the slat 1 is inserted so as to be located between the first intersecting portion 7a and the warp thread 5b.

Also in this case, the same effects can be obtained as in the case where the slat 1 is inserted, as shown in FIG. 23, on the side of the second warp thread 5b, in the space formed by the first weft thread 6a, the fourth weft thread 6d and the second warp thread 5b.

Similarly, the above embodiment may be implemented such that, as shown in FIG. 26, on the side of the second warp thread 5b, the slat 1 is inserted in a space formed by the first weft thread 6a, the second weft thread 6b, the fourth weft thread 6d and the second warp thread 5b. Here, the slat 1 is inserted so as to be located between the third intersecting portion 7c and the warp thread 5b.

Also in this case, the same effects can be obtained as in the case where the slat 1 is inserted, as shown in FIG. 23, on the side of the second warp thread 5b, in the space formed by the first weft thread 6a, the fourth weft thread 6d and the second warp thread 5b.

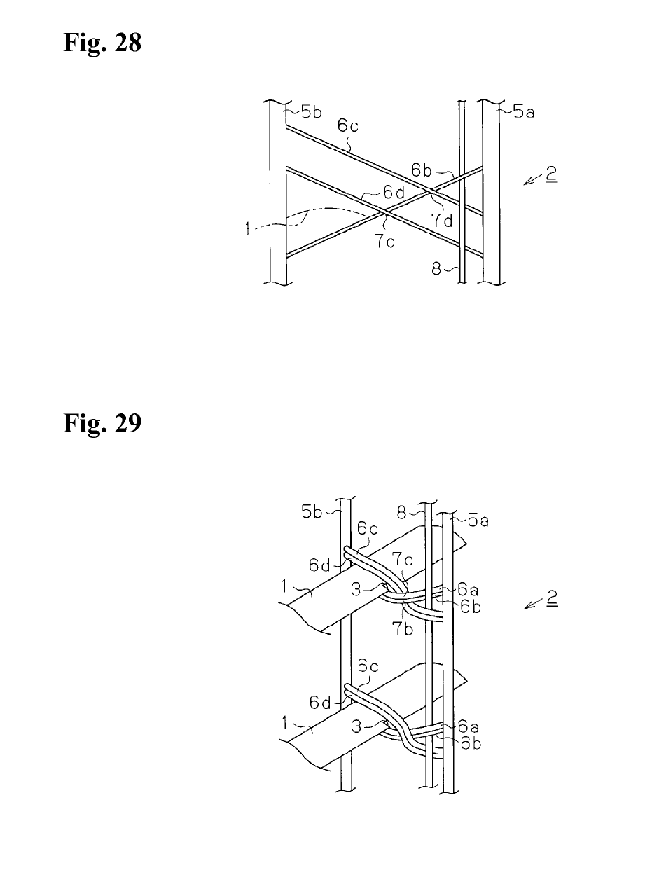

Further, as shown in FIG. 28, the above embodiment may be implemented such that either one of the first weft thread 6a and the second weft thread 6b is omitted (the first weft thread 6a is omitted in FIG. 28). Obviously, in contrast as shown in FIG. 27, the above embodiment may be implemented such that either one of the third weft thread 6c and the fourth weft thread 6d is omitted (the fourth weft thread 6d is omitted in FIG. 27).

Moreover, the above embodiment may be implemented such that, as shown in FIG. 29, the intersections of the first and second weft threads 6a, 6b with the third and fourth weft threads 6c, 6d are different between an upper rung and a lower rung. In this case, the lifting/lowering cord 8 is inserted such that, at the second and fourth intersecting portions 7b, 7d of the first and second weft threads 6a, 6b and the third and fourth weft threads 6c, 6d, the first and second weft threads 6a, 6b intersects with the third and fourth weft threads 6c, 6d as seen from above (from the head box).

In this configuration, since the first to fourth weft threads 6a-6d are interposed between the lifting/lowering cord 8 and the edge of the notch 3 of each rung, wear of the lifting/lowering cord 8 can be suppressed further.

### Eighth Embodiment

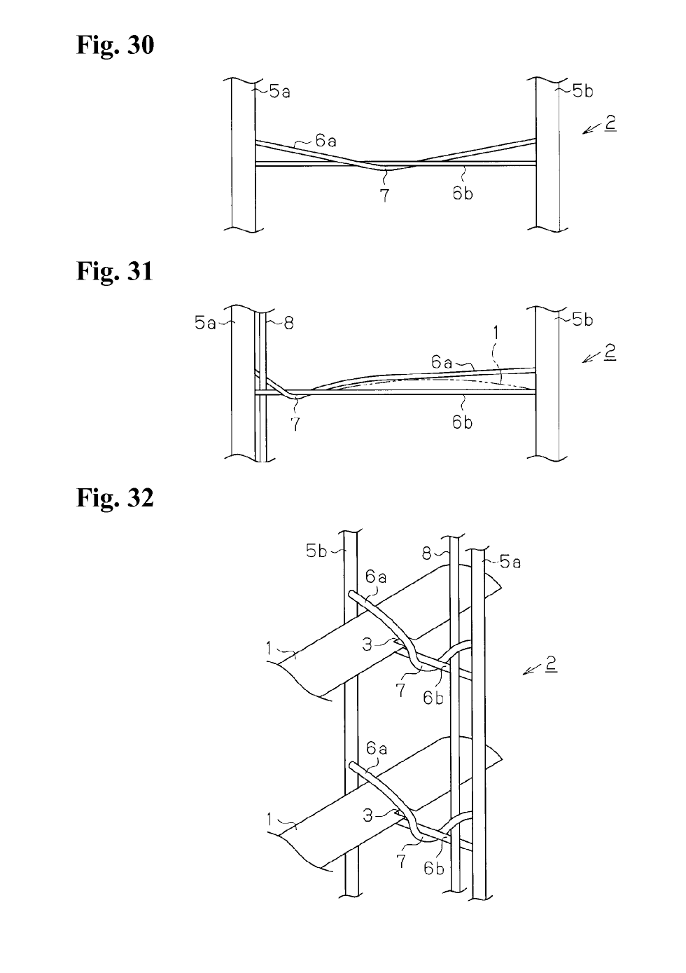

FIGS. 30 to 32 show an eighth embodiment. This embodiment is characterized in that a ladder cord having a closed space formed beforehand is used eliminating the need for caring the direction of insertion of the lifting/lowering cord.

As shown in FIG. 30, in the ladder cord 2, both ends of the second weft thread 6b are formed on the first warp thread 5a and the second warp thread 5b so as to be located at the same level.

The first weft thread 6a is formed such that an end thereof on the side of the first warp thread 5a is located above the end of the second weft thread 6b. Further, the first weft thread 6a is formed such that it passes under (is wound half around) the second weft thread 6b and an end thereof on a side of the second warp thread 5b is located above the end of the second weft thread 6b.

Therefore, the first weft thread 6a is coupled to the first warp thread 5a and the second warp thread 5b in a state where it is engaged with the second weft thread 6b located below the first weft thread 6a, so that the intersecting portion 7 is formed resulting from that engagement. Consequently, in the ladder cord 2, a closed space is formed in advance by surrounding with the warp thread 5a and the weft threads 6a, 6b.

As shown in FIG. 31 by a double-dotted chain line and in FIG. 32, the slat 1 is inserted between the intersecting portion 7 and the second warp thread 5b such that the intersecting portion 7 resulting from the engagement of the first weft thread 6a with the second weft thread 6b is located in the notch 3.

Further, as shown in FIGS. 31 and 32, the lifting/lowering cord 8 is inserted in the space (closed space) formed between the first weft thread 6a and the second weft thread 6b at a location between the intersecting portion 7 located within the notch 3 and the first warp thread 5a.

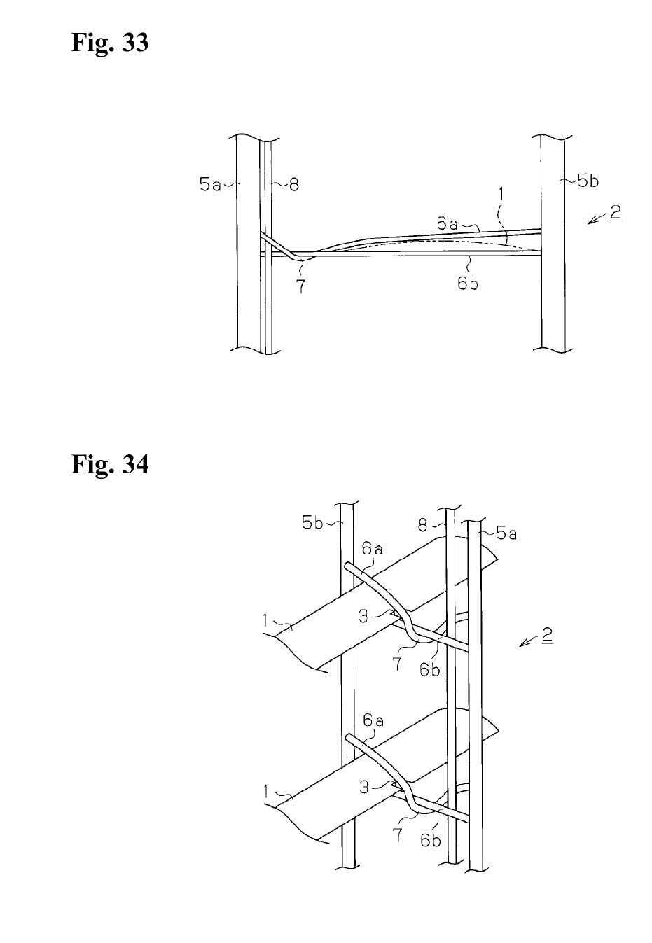

Here, since the intersecting portion 7 is formed by the engagement of the first weft thread 6a and the second weft thread 6b, the lifting/lowering cord 8 may be inserted as shown in FIGS. 33 and 34. Also in this case, the lifting/lowering cord 8R does not go to the side of the slat 1 unlike the case where the weft threads 6aR, 6bR do not intersect as seen from above.

Therefore, according to this embodiment, the first and second weft threads 6a, 6b are interposed doubly between the lifting/lowering cord 8 and the edge of the notch 3 in each rung, so that wear of the lifting/lowering cord 8 can be suppressed further.

Note that, in the above embodiment, the intersecting portion 7 is formed such that the first weft thread 6a passes under the second weft thread 6b and, in this state, the end of the first weft thread 6a is formed on the side of the second warp thread 5b at the location above the second weft thread 6b, which configuration is so called a half-engagement (half entanglement).

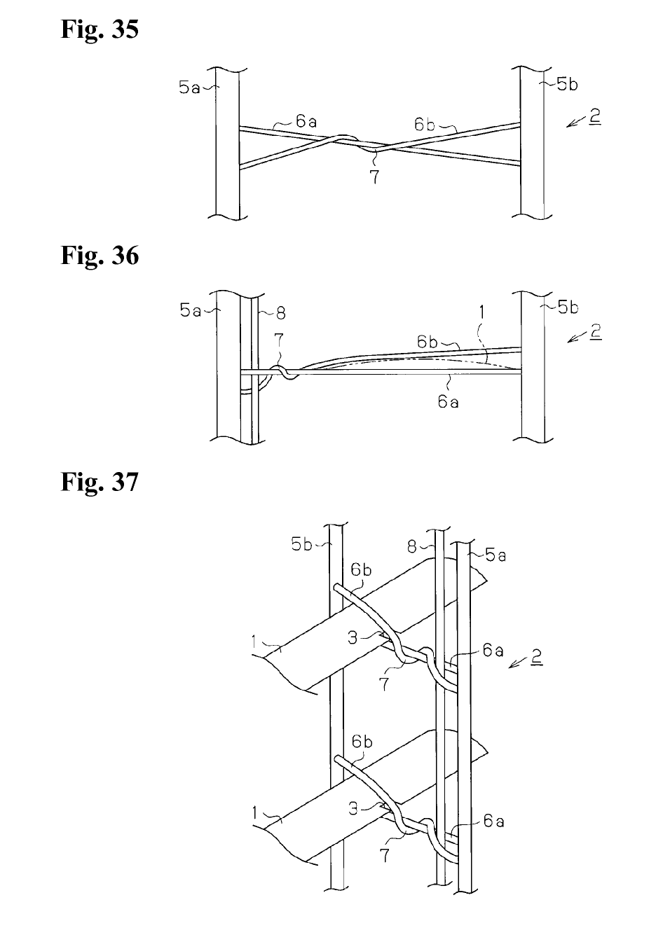

Alternatively, a configuration may be adopted where, as shown in FIG. 35, the second weft thread 6b is entangled once with (wound once around) the first weft thread 6a to form the intersecting portion 7.

To be more specific, as shown in FIG. 35, in the ladder cord 2, the end of the first weft thread 6a is formed on the first warp thread 5a so as to be located above the end of the second weft thread 6b. Also, the end of the second weft thread 6b is formed on the second warp thread 5b so as to be located above the end of the first weft thread 6a.

Here, the second weft thread 6b is wound once around the first weft thread 6a, and the both ends of the second weft thread 6b are formed on the first warp thread 5a and the second warp thread 5b.

Further, as shown in FIG. 36 by a double-dotted chain line and in FIG. 37, the slat 1 is inserted between the intersecting portion 7 and the second warp thread 5b such that the intersecting portion 7 resulting from the one winding of the second weft thread 6b around the first weft thread 6a is located in the notch 3.

Further, as shown in FIG. 37, the lifting/lowering cord 8 is inserted in the space formed between the first weft thread 6a and the second weft thread 6b at the location between the intersecting portion 7 located within the notch 3 and the first warp thread 5a.

According to this configuration, similarly, wear of the lifting/lowering cord 8 can be suppressed further.

### Ninth Embodiment

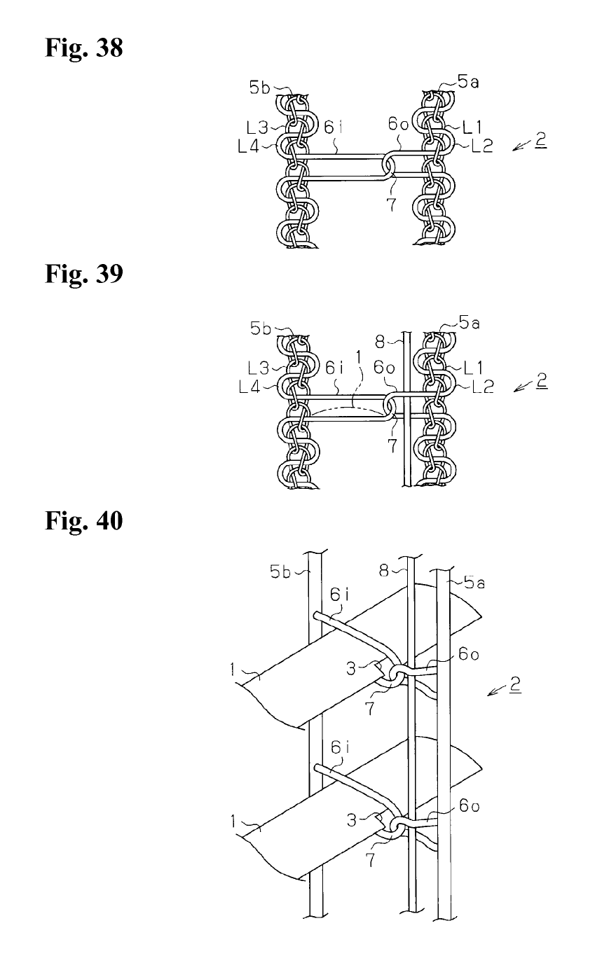

FIGS. 38 to 40 show a ninth embodiment.

As shown in FIG. 38, in the ladder cord 2, the first warp thread 5a is formed by interweaving a second knitting yarn L2 with a first knitting yarn L1 woven from a single yarn such that they are entangled with each other. The second knitting yarn L2 is, while being interwoven with the first knitting yarn L1, pulled out toward the second warp thread 5b at regular intervals. The second knitting yarn L2 pulled out toward the second warp thread 5b, having a loop shape, is used as an outside weft thread 6o.

The second warp thread 5b is formed by interweaving a fourth knitting yarn L4 with a third knitting yarn L3 woven from a single yarn such that they are entangled with each other. The fourth knitting yarn L4 is, while being interwoven with the third knitting yarn L3, pulled out toward the first warp thread 5a at regular intervals, and inserted in the loop of the outside weft thread 6o formed of the second knitting yarn L2. The fourth knitting yarn L4, which is pulled out toward the first warp thread 5a, inserted in the loop of the outside weft thread 6o, and has a loop shape, is used as an inside weft thread 6i.

Thus, the loop of the inside weft thread 6i is inserted in the loop of the outside weft thread 6o so that the outside weft thread 6o and the inside weft thread 6i are coupled together, and an intersecting portion 7 is formed between the outside weft thread 6o and the inside weft thread 6i. As a result, a closed space is formed by the warp thread 5a and the outside weft thread 6o.

Further, the inside weft thread 6i is formed longer than the outside weft thread 6o, so as to have a length sufficient to insert the slat 1 therein, as shown in FIG. 39 by a double-dotted chain line.

As shown in FIGS. 39 and 40, the slat 1 is inserted in the loop of the inside weft thread 6i such that the intersecting portion 7 resulting from the coupling of the outside weft thread 6o and the inside weft thread 6i is located in the notch 3.

Similarly, as shown in FIGS. 39 and 40, the lifting/lowering cord 8 is inserted in the space (closed space) formed by the loop of the outside weft thread 6o coupled to the inside weft thread 6i located in the notch 3.

Thus, according to this embodiment, the outside and inside weft threads 6o, 6i are interposed between the lifting/lowering cord 8 and the edge of the notch 3 in each rung, so that wear of the lifting/lowering cord 8 can be suppressed further.

Note that the first knitting yarn L1 composing the first warp thread 5a and the third knitting yarn L3 composing the second warp thread 5b are made of a same material, and the second knitting yarn L2 composing the first warp thread 5a and the fourth knitting yarn L4 composing the second warp thread 5b are also made of a same material. Alternatively, enhancing the strength of the second knitting yarn L2 of the outside weft thread 6o in which the lifting/lowering cord 8 is inserted, by increasing the thickness thereof or using as the material thereof an aramid fiber, an ultrahigh molecular weight polyethylene fiber and the like, which have high tolerability to friction, will produce still better effects. In contrast, the fourth knitting yarn L4 of the inside weft thread 6i for supporting the slat 1 may be implemented with a softer fiber, which will facilitate inserting operation of the slat 1.

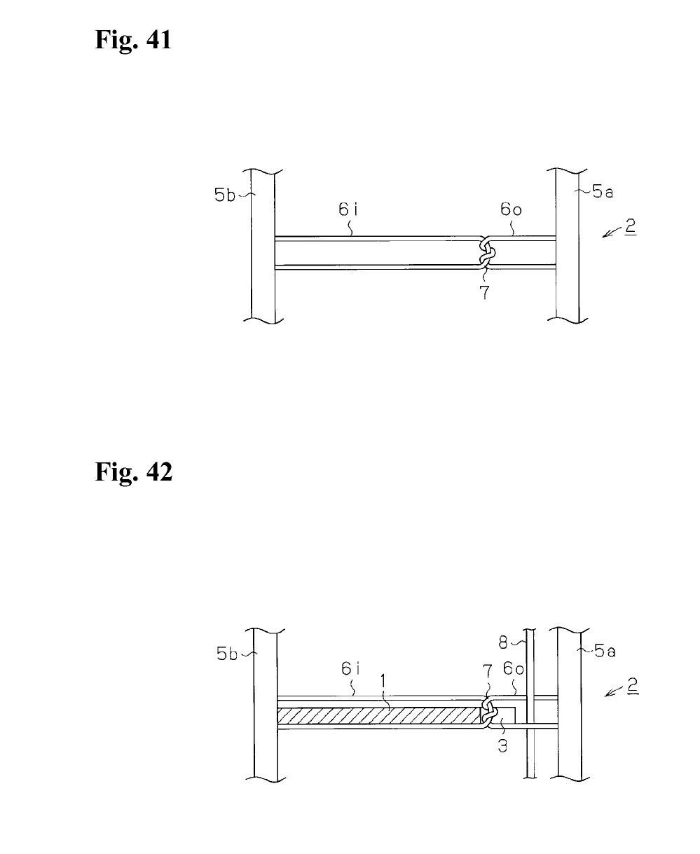

Further, as shown in FIGS. 41 and 42, this embodiment may be implemented such that the outside weft thread 6o made of the above-mentioned aramid fiber, an ultrahigh molecular weight polyethylene fiber or the like having high tolerability to friction is entangled doubly (or more). This makes it possible to increase strength of the yarn forming the closed space, and thus, enhance frictional property thereof in relation to the lifting/lowering cord 8, while keeping flexibility of the weft threads and maintaining shielding performance of the slat. In this case, by pulled out both the second knitting yarn L2 and the fourth knitting yarn L4 such that the distance between the upper portion and the lower portion of each of the outside weft thread 6o and the inside weft thread 6i is large, insertion operation of the slat 1 and that of the lifting/lowering cord 8 are both facilitated.

### Tenth Embodiment

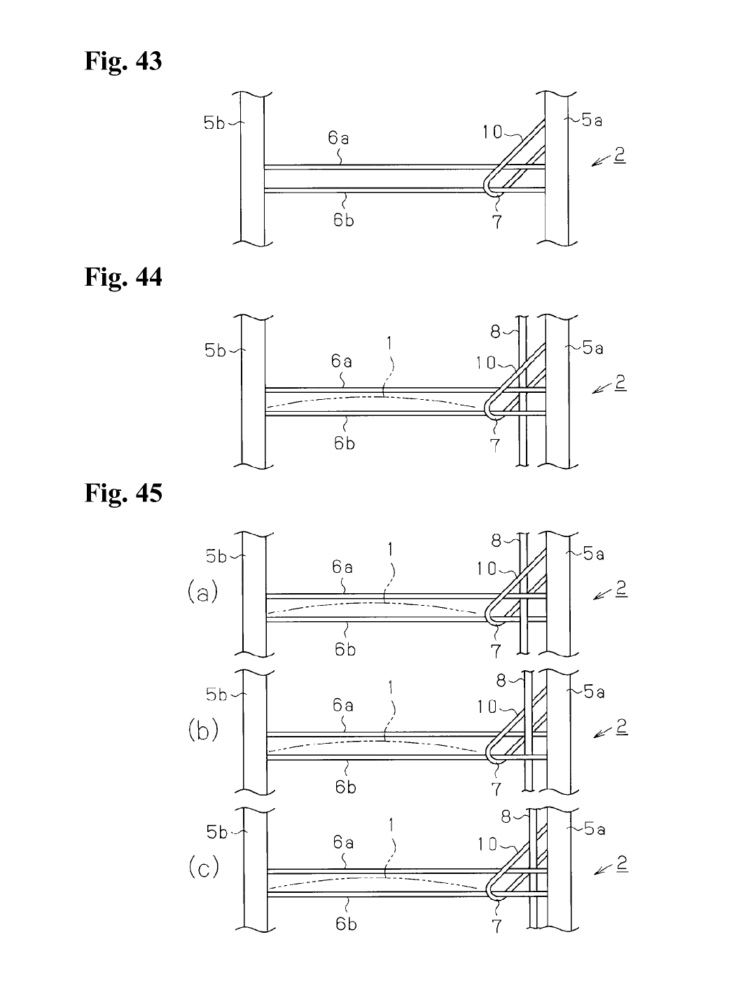

FIGS. 43 to 45 show a tenth embodiment.

As shown in FIG. 43, the first weft thread 6a and the second weft thread 6b are formed horizontally between the first warp thread 5a and the second warp thread 5b so as to be parallel to each other, with the ends thereof on the warp threads.

Further, a guide ring 10 is provided on the first warp thread 5a at a location above the end of the first weft thread 6a. The guide ring 10 is provided such that the first and second weft threads 6a, 6b formed in parallel between the first and second warp threads 5a, 5b pass therethrough.

Thus, with the first and second weft threads 6a, 6b inserted in the guide ring 10, an intersecting portion 7 is formed between the guide ring 10 and the second weft thread 6b.

As shown in FIG. 44 by a double-dotted chain line, the slat 1 is inserted between the first weft thread 6a and the second weft thread 6b at a location between the second warp thread 5b and the notch 3 such that the intersecting portion 7 is located in the notch 3. Further, as shown in FIG. 44, the lifting/lowering cord 8 is inserted in the guide ring 10 and lead to the guide ring 10 of the next rung, by way of one side of the first and second weft threads 6a, 6b, and inserted therein.

Thus, in the horizontal blind of this embodiment, the lifting/lowering cord 8 is inserted in the guide ring 10 every pitch of the first and second weft threads 6a, 6b, so that it is possible to reduce friction of the lifting/lowering cord 8 with the first and second weft threads 6a, 6b, and friction thereof with the notch 3.

Note that, in this embodiment, the lifting/lowering cord 8 is inserted in the guide ring 10 but lead by way of one side of the first and second weft threads 6a, 6b.

Alternatively, a configuration may be adopted where, as shown in FIG. 45 (a), the lifting/lowering cord 8 is inserted in the guide ring 10 and lead through a space between the first weft thread 6a and the second weft thread 6b. Further, another configuration may be adopted where, as shown in FIG. 45 (b), the lifting/lowering cord 8 is not inserted in the guide ring 10 but lead through the space between the first weft thread 6a and the second weft thread 6b. Moreover, still another configuration may be adopted where, as shown in FIG. 45 (c), the lifting/lowering cord 8 is not inserted in the guide ring 10 nor in the space between the first weft thread 6a and the second weft thread 6b, but inserted in a space between the guide ring 10 and the first and second weft threads 6a, 6b.

In this embodiment, both of the first and second weft threads 6a, 6b are inserted in the guide ring 10.

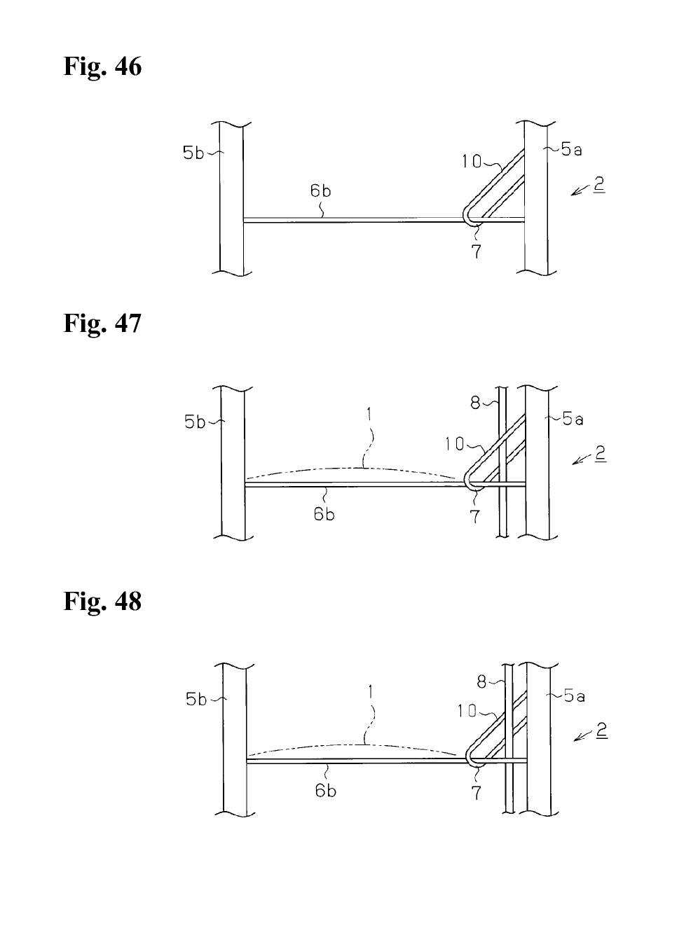

In the case where, as shown in FIGS. 46 and 47, only one weft thread (the second weft thread 6b in the case of FIG. 46) is formed between the first warp thread 5a and the second warp thread 5b, that is, in the case where no restriction is required on the top of the slat 1, such a configuration may be adopted where the only one (second) weft thread 6b is inserted in a guide ring 10 formed, on the first warp thread 5a, of the above-mentioned aramid fiber, ultrahigh molecular weight polyethylene fiber or the like having high tolerability to friction. Further, the slat 1 may be disposed on the second weft thread 6b and the lifting/lowering cord 8 may be inserted in the guide ring 10.

Moreover, as shown in FIG. 48, a configuration may be adopted where the lifting/lowering cord 8 is not inserted in the guide ring 10 but inserted in a space (closed space) formed between the guide ring 10 and the second weft thread 6b.

### Eleventh Embodiment

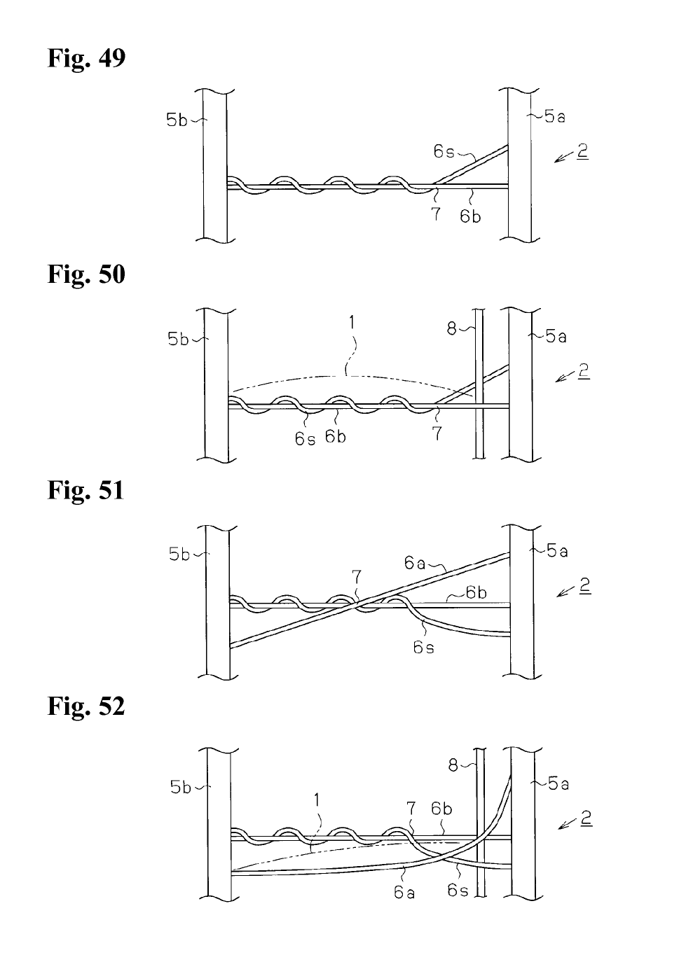

FIGS. 49 and 50 show an eleventh embodiment.

As shown in FIGS. 49 and 50, one weft thread (second weft thread 6b in the case of FIGS. 49 and 50) is formed between the first warp thread 5a and the second warp thread 5b. A helical weft thread 6s is entangled with the second weft thread 6b in a helical manner. Here, the entangled helical weft thread 6s is fixed to the second weft thread 6b through heat-setting with the second weft thread 6b.

An end of entanglement, closer to the second warp thread 5b, of the helical weft thread 6s is in the close vicinity of the second warp thread 5b, and an end of the weft thread 6s is formed on the second warp thread 5b at a location above and near the second weft thread 6b. On the other hand, another end of entanglement, closer to the first warp thread 5a, of the helical weft thread 6s is at a predetermined distance from the first warp thread 5a, and another end of the weft thread 6s is formed on the first warp thread 5a at a location above and at a predetermined distance from the second weft thread 6b.

Further, as shown in FIG. 50 by a double-dotted chain line, the slat 1 is disposed above the second weft thread 6b such that a detached portion of the helical weft thread 6s which is away from the second weft thread 6b and formed on the first warp thread 5a is located in the notch 3. As shown in FIG. 50, the lifting/lowering cord 8 is inserted in a space (closed space) formed by the detached portion of the helical weft thread 6s, the second weft thread 6b and the first warp thread 5a.

Thus, in the horizontal blind of this embodiment, the detached portion of the helical weft thread 6s is located within the notch 3, so that misalignment in the right and left direction, i.e., the longitudinal direction, is prevented. Further, since the lifting/lowering cord 8 is disposed between the detached portion of the helical weft thread 6s and the second weft thread 6b, friction thereof with the notch 3 of the slat 1 is prevented.

Note that this embodiment is configured such that the helical weft thread 6s is formed on the first warp thread 5a at a location above the second weft thread 6b. Instead of this configuration, as shown in FIG. 51, the end of the helical weft thread 6s on the side of the first warp thread 5a may be formed on the first warp thread 5a at a location below the second weft thread 6b and at a predetermined distance therefrom.

Alternatively, as shown in FIG. 51, the first weft thread 6a is formed, between the first warp thread 5a and the second warp thread 5b, so as to intersect with the second weft thread 6b which is entangled with the helical weft thread 6s in a helical manner. To be more specific, an end of the first weft thread 6a is formed on the first warp thread 5a so as to be located above the end of the second weft thread 6b. Also, another end of the first weft thread 6a is formed on the second warp thread 5b so as to be located below the end of the second weft thread 6b.

Therefore, as shown in FIG. 51, the first weft thread 6a and the second weft thread 6b entangled with the helical weft thread 6s intersect with each other at an intermediary location thereof, and an intersecting portion 7 is formed as a result of the intersection.

Further, a space allowing the slat 1 to be inserted therein is secured between the intersecting portion 7 and the second warp thread 5b by sliding the intersecting portion 7 toward the first warp thread 5a by means of the operation shaft 9 (see FIG. 5) for inserting the slat 1, and, as shown in FIG. 52 by a double-dotted chain line, the slat 1 is inserted between the first weft thread 6a and the second weft thread 6b at a location between the intersecting portion 7 and the second warp thread 5b.

Further, as shown in FIG. 52, the lifting/lowering cord 8 is inserted in a space (closed space) formed by the detached portion of the helical weft thread 6s, the second weft thread 6b and the first warp thread 5a.

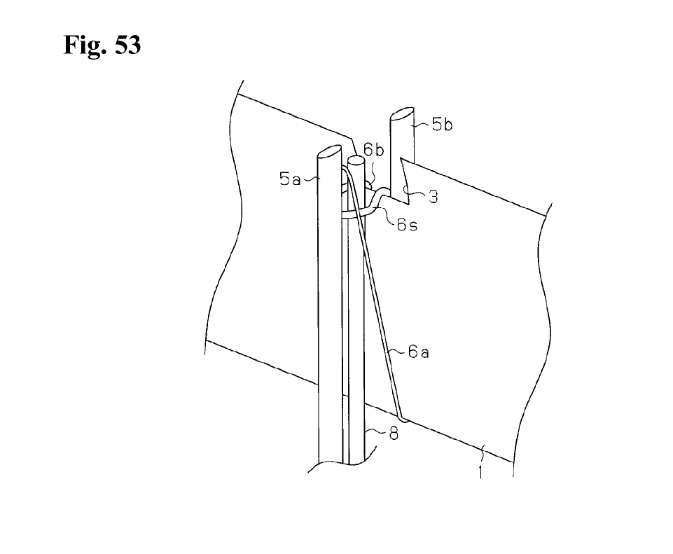

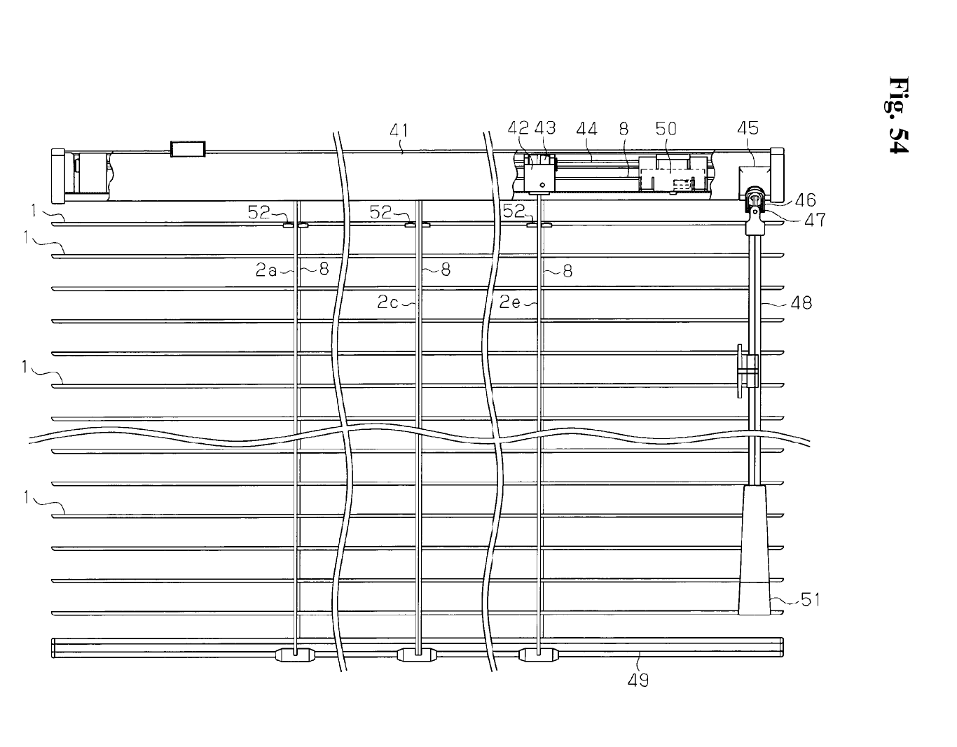

Thus, as show in FIG. 53, the lifting/lowering cord 8 passes between the detached portion of the helical weft thread 6s existing within the notch 3 and the second weft thread 6b, so that lateral misalignment is restricted not only in the forwardly fully-closed state but also in the contrariwise fully-closed state. Similarly, since the lifting/lowering cord 8 is disposed between the detached portion of the helical weft thread 6s and the second weft thread 6b, friction thereof with the edge of the notch 3 of the slat 1 is prevented.

### Twelfth Embodiment

FIGS. 54 to 58 show a twelfth embodiment.

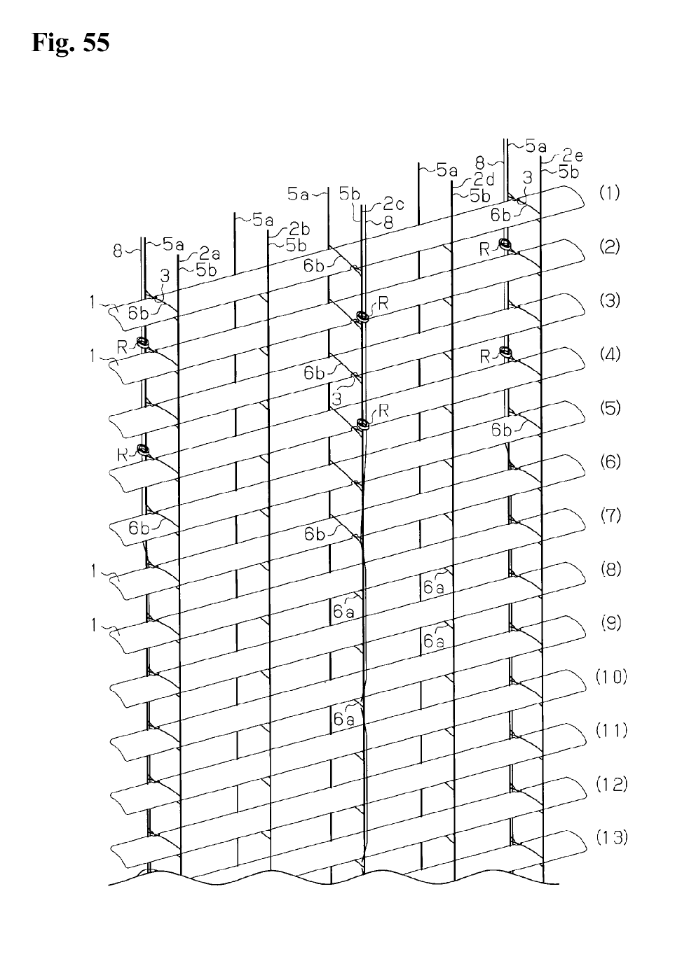

In the horizontal blind shown in FIG. 54, multiple (five in this embodiment, as shown in FIG. 55) ladder cords 2a-2e are suspended at regular intervals from a head box 41, and a number of rungs of slats 1 are supported by the ladder cords 2a-2e.

At a location above each of the ladder cords 2a-2e, a supporting member 42 is disposed in the head box 41, and a ladder cord-suspending shaft 43 is supported so as to be rotatable by the supporting member 42, and an upper end of each of the ladder cords 2a-2e, is attached to the ladder cord-suspending shaft 43. When the ladder cord-suspending shaft 43 is rotated, the slats 1 are turned in the same phase through the ladder cords 2a-2e.

An angle-adjusting shaft 44 formed into a hexagonal rod is inserted into the ladder cord-suspending shaft 43 such that their relative rotation is not possible, and one end of the angle-adjusting shaft 44 is fitted with an output shaft of an operation apparatus 45 provided at a right end of the head box 41.

A gear mechanism is arranged in the operation apparatus 45, and an input shaft 46 of the gear mechanism protrudes obliquely downward from the head box 41 toward the interior of the room. Further, an operation rod 48 is suspended from an end of the input shaft 46 via a universal joint 47.

According to the above configuration, the angle-adjusting shaft 44 is rotated by a rotational operation of the operation rod 48 through the operation apparatus 45, so that the ladder cord-suspending shaft 43 is rotated integrally with the angle-adjusting shaft 44.

In the vicinities of the suspending locations of the ladder cords 2a, 2c, 2e among the ladder cords 2a-2e, suspended at both sides of the head box 41 in the longitudinal direction and at an intermediary location, three lifting/lowering cords 8 are suspended from the head box 41. Among the three lifting/lowering cords 8, the lifting/lowering cords 8 suspended at the both sides of the head box 41 extend downward along first warp threads 5a of the ladder cords 2a, 2e on the side of the slat 1 facing exterior of the room, and the lifting/lowering cord 8 suspended at the intermediary location of the head box 41 extends downward along a second warp thread 5b of the ladder cord 2c on the side of the slat 1 facing interior of the room.

A bottom rail 49 is attached to lower ends of the ladder cords 2a-2e and the lifting/lowering cords 8. When the lifting/lowering cords 8 are lifted, the bottom rail 49 is lifted so that the slats 1 are lifted.

Upper ends of the lifting/lowering cords are guided into the head box 41, and, in FIG. 54, guided toward the right end of the head box 41. The upper ends are arranged within the head box 41, inserted in the operation rod 48 by way of a stopper apparatus 50 and the input shaft 46 of the operation apparatus 45, and attached to a cord-equalizer 51 below a handle attached to an lower end of the operation rod 48.

Further, in FIG. 54, slat-restricting members 52 are attached to the slat 1 of the uppermost rung at the locations where the lifting/lowering cords 8 are suspended, and the slat-restricting members 52 are engaged with the first and second warp threads 5a, 5b of the ladder cords 2a, 2c, 2e and the lifting/lowering cords 8 so as to prevent lateral misalignment of the slat 1.

FIG. 55 is a perspective view showing a state where the multiple slats 1 are supported by the multiple ladder cords 2a-2e. Note that, in FIG. 55, the slat-restricting members 52 are not shown for convenience of explanation.

Each of the slats 1 is provided with notches 3 at both right and left ends at one side thereof (on a side of the first warp threads 5a), as shown in FIG. 55. Further, each of the slats 1 of the first to sixth rungs from the top is formed with a notch 3 at a middle position at another side thereof (on a side of the second warp threads 5b).

To each rung of each of the ladder cords 2a-2e, the configuration of the first embodiment shown in FIG. 3 is applied.

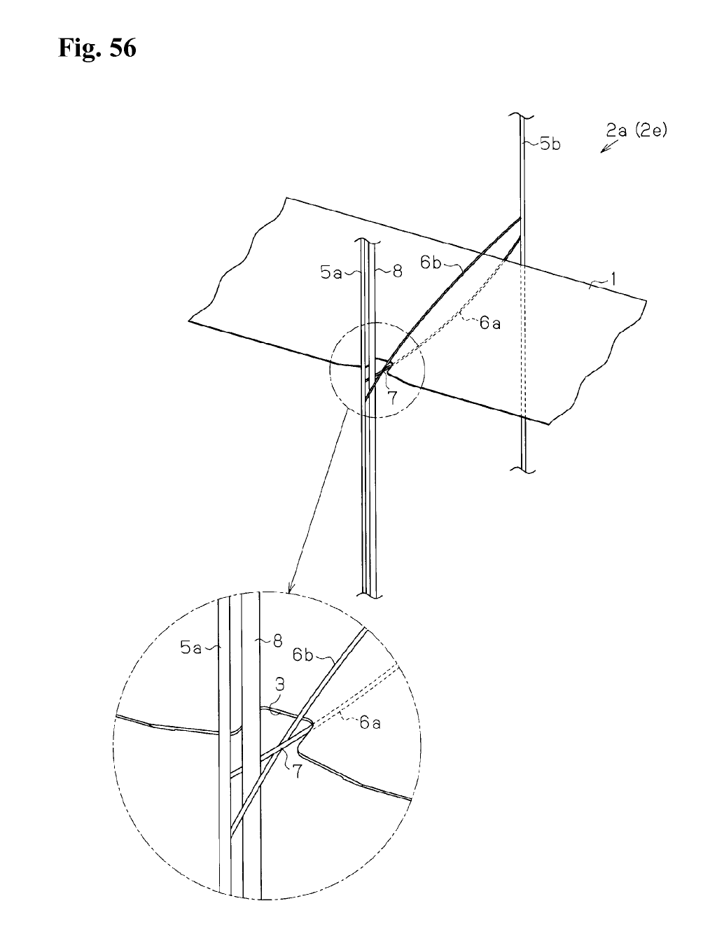

As shown in FIGS. 55 and 56, the slat 1 of each rung is, in a relationship of the right and left sides thereof to the right and left ladder cords 2a, 2e, inserted in a space formed by the intersecting portion 7, the first weft thread 6a, the second weft thread 6b and the second warp thread 5b such that the intersecting portion 7 is located in the notch 3 formed on the side of the first warp thread 5a.

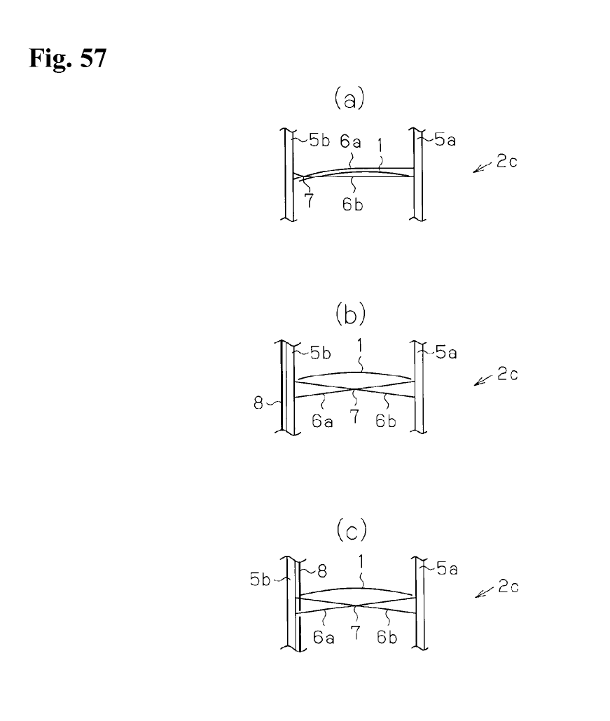

Further, a middle portion of each slat 1 of the first to sixth rungs from the top in FIG. 55 is, as shown in FIG. 57 (a), in relation to the central ladder cord 2c, inserted in a space formed by the intersecting portion 7, the first weft thread 6a, the second weft thread 6b and the first warp thread 5a such that the intersecting portion 7 is located in the notch 3 formed on the side of the second warp thread 5b.

A middle portion of each slat 1 of the seventh rung from the top and lower rungs in FIG. 55 is, as shown in FIGS. 57 (b) and 57 (c), in relation to the central ladder cord 2c, disposed on the first weft thread 6a and the second weft thread 6b intersecting with each other, at a location between the first warp thread 5a and the second warp thread 5b.

Also, an intermediary portion between the left side and the middle portion of the slat 1 of each rung is, in relation to the ladder cord 2b provided between the ladder cord 2a at the left side and the central ladder cord 2c, disposed on the first weft thread 6a and the second weft thread 6b intersecting with each other, at a location between the first warp thread 5a and the second warp thread 5b. Similarly, an intermediary portion between the right side and the middle portion of the slat 1 of each rung is, in relation to the ladder cord 2d provided between the ladder cord 2e at the right side and the central ladder cord 2c, disposed on the first weft thread 6a and the second weft thread 6b intersecting with each other, at a location between the first warp thread 5a and the second warp thread 5b.

Further, in the ladder cords 2a, 2e at the right and left sides, as shown in FIG. 55, rings R are provided in which are inserted portions of the first warp thread 5a at locations above the first weft threads 6a of the second and fourth rungs from the top, and the lifting/lowering cords 8 at the right and left sides are inserted respectively in the rings R. Further, in the first, third and fifth rungs, the lifting/lowering cords 8 are not inserted in a space formed by the first weft thread 6a, the second weft thread 6b and the first warp thread 5a, at a location between the intersecting portion 7 and the first warp thread 5a.

Note that the rings R of the second and fourth rungs may be different in size. For example, a configuration may be adopted where the size of the ring R of the second rung is greater than the size of the ring R of the fourth rung.

Next, in the ladder cords 2a, 2e at the right and left sides at the sixth rung and lower rungs, as shown in FIG. 56, the lifting/lowering cords 8 at the right and left sides are inserted in the space formed by the first weft thread 6a, the second weft thread 6b and the first warp thread 5a, at the location between the intersecting portion 7 and the first warp thread 5a.

On the other hand, in the central ladder cord 2c, at the first to sixth rungs from the top in FIG. 55, similarly to the ladder cords 2a, 2e at the right and left sides, rings R are provided in which are inserted portions of the second warp thread 5b at locations above the second weft threads 6b of the second and fourth rungs, and the central lifting/lowering cords 8 is inserted in the rings R.

Next, in the ladder cord 2c at the sixth rung and lower rungs, the central lifting/lowering cords 8 is, as shown in FIGS. 55 and 57 (c), inserted, every three rungs starting from the sixth rung of the central ladder cord 2c, in a space formed by the first weft thread 6a, the second weft thread 6b and the second warp thread 5b, at a location between the intersecting portion 7 and the second warp thread 5b.

Therefore, as shown in FIGS. 55 and 57 (b), the lifting/lowering cord 8 is not inserted in the above-mentioned spaces formed in the first, third, fifth, seventh, eighth, tenth and eleventh rungs.

Note that in the case of inserting the lifting/lowering cord 8 in that space, it is inserted in the same manner as the lifting/lowering cords 8 at the right and left sides.

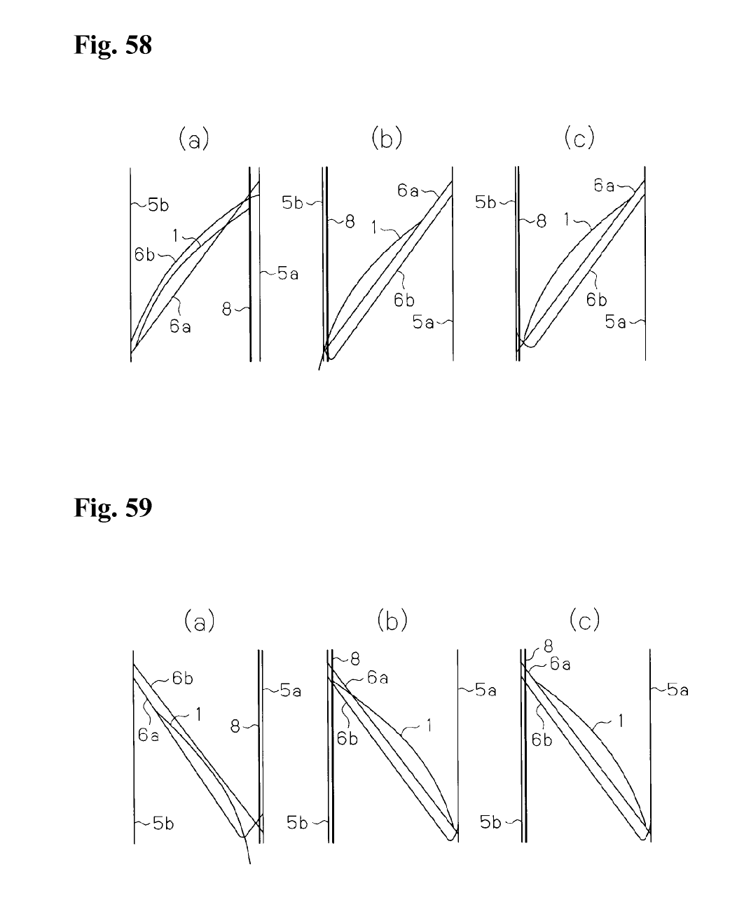

According to the configuration described above, when the slats 1 are changed from the horizontal attitude to the contrariwise fully-closed state, both the right and left sides of the slat 1 are arranged as shown in FIG. 58 (a). The middle portion of the slat 1 having the notch 3 in the middle portion is arranged as shown in FIG. 58 (b), and the middle portion of the slat 1 without the notch 3 in the middle portion is arranged as shown in FIG. 58 (c).

As a result, in the contrariwise fully-closed state, as shown in FIGS. 58 (b) and 58 (c), the first weft thread 6a is tightened, and thus, presses the slat 1 in a direction it falls over, so that shielding performance of the slat 1 is increased.

In contrast, when the slats 1 are changed from the horizontal attitude to the fully-closed state, both the right and left sides of the slat 1 are arranged as shown in FIG. 59 (a). The middle portion of the slat 1 having the notch 3 in the middle portion is arranged as shown in FIG. 59 (b), and the middle portion of the slat 1 without the notch 3 in the middle portion is arranged as shown in FIG. 59 (c).

As a result, in the fully-closed state, as shown in FIGS. 59 (b) and 59 (c), the first weft thread 6a is tightened, and thus, presses the slat 1 in a direction it falls over, so that shielding performance of the slat 1 is increased.

As described above, according to this embodiment, a horizontal blind can be obtained which has not only the advantageous effects of the other embodiments described previously but also a further enhanced shielding performance.

Note that, in this embodiment, in the ladder cords 2a, 2e at the right and left sides, the lifting/lowering cord 8 is inserted in the space formed by the first weft thread 6a, the second weft thread 6b and the first warp thread 5a, at the location between the intersecting portion 7 and the first warp thread 5a. Also, in the central ladder cord 2c, the lifting/lowering cord 8 is inserted in the space formed by the first weft thread 6a, the second weft thread 6b and the second warp thread 5b, at the location between the intersecting portion 7 and the second warp thread 5b.

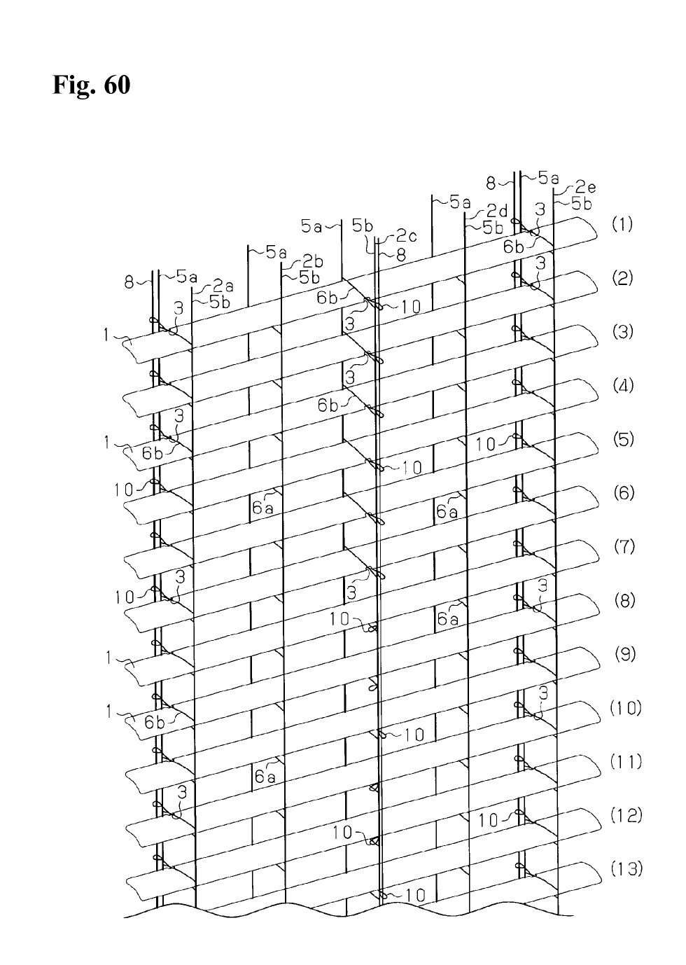

Alternatively, a configuration may be adopted where a guide ring 10 is provided, as shown in FIG. 60, at each rung of the first warp thread 5a of the ladder cords 2a, 2c at the right and left sides and at each rung of the second warp thread 5b of the central ladder cord 2c, and the lifting/lowering cords 8 are inserted in the guide rings 10.

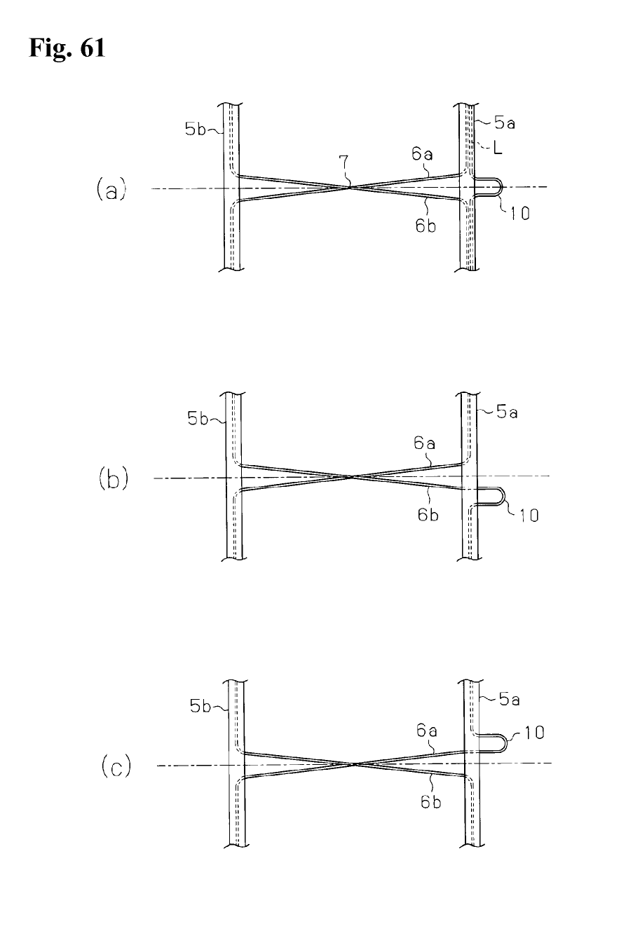

In this case, the guide rings 10 may be formed, for example, as shown in FIGS. 61 (a), 61 (b) and 61 (c).

Hereafter, a method of forming the first and second weft threads 6a, 6b as well as the guide ring 10 will be described.

As shown in FIG. 61 (a), the first warp thread 5a is composed of multiple stings L. The second warp thread 5b is also composed of multiple stings L. Further, one (but not necessarily limited to one) string L of the first warp thread 5a is pulled out as the first weft thread 6a toward the second warp thread 5b, and one (but not necessarily limited to one) string L of the second warp thread 5b is pulled out as the second weft thread 6b toward the first warp thread 5a. Here, the one string L of the first warp thread 5a that is pulled out as the first weft thread 6a and the one string L of the second warp thread 5b that is pulled out as the second weft thread 6b are pulled out from locations at the same level.

The string L of the first warp thread 5a that has been pulled out as the first weft thread 6a is used as a string composing the second warp thread 5b instead of the string L of the second warp thread 5b that has been pulled out, below the location at which the string L of the second warp thread 5b has been pulled out. On the other hand, the string L of the second warp thread 5b that has been pulled out as the second weft thread 6b is used as a string composing the first warp thread 5a instead of the string L of the first warp thread 5a that has been pulled out, below the location at which the string L of the first warp thread 5a has been pulled out.

Then, in the next rung, the string L that was once in the second weft thread 6b and is now in the first warp thread 5a is pulled out toward the second warp thread 5b as the first weft thread 6a, in the same manner as above. On the other hand, the string L that was once in the first weft thread 6a and is now in the second warp thread 5b is pulled out toward the first warp thread 5a as the second weft thread 6b, in the same manner as above.

Then, similarly, the string L of the first warp thread 5a that has been pulled out as the first weft thread 6a is used as a string composing the second warp thread 5b instead of the string L of the second warp thread 5b that has been pulled out. Meanwhile, the string L of the second warp thread 5b that has been pulled out as the second weft thread 6b is used as a string composing the first warp thread 5a instead of the string L of the first warp thread 5a that has been pulled out.

Thereafter, by repeating the above process, the first weft thread 6a and the second weft thread 6b intersecting each other are formed in each of the rungs.

Along with the formation of the first and second weft threads 6a, 6b, as shown in FIG. 61 (a), in the first warp thread 5a, one string L among the plural strings of the first warp thread 5a other than the string composing the first weft thread 6a is pulled out in a shape of a loop, at a location between the first weft thread 6a and the second weft thread 6b, to form the guide ring 10 of the first warp thread 5a. Here, the guide ring 10 is formed at a location at the same level as the intersecting portion 7 of the first weft thread 6a and the second weft thread 6b.

Note that, as an alternative way of forming the guide ring 10, as shown in FIG. 61 (b), the string L that has been pulled out from the second warp thread 5b as the second weft thread 6b may be pulled out from the first warp thread 5a in the form of a loop to form the guide ring 10, before it is used as the string L composing the first warp thread 5a.

Further, as shown in FIG. 61 (c), the string L that is to be pulled out from the first warp thread 5a as the first weft thread 6a may be pulled out from the first warp thread 5a in the form of a loop to form the guide ring 10, before it is pulled out from the first warp thread 5a.

### DESCRIPTION OF THE REFERENCE SYMBOLS

1: slat; 2: ladder cord; 2L: left-side ladder cord; 2R: right-side ladder cord; 3: notch; 3L: left-side notch; 3R: right-side notch; 5a: warp thread (first warp thread); 5b: warp thread (second warp thread); 5aL: left-side first warp thread; 5aR: right-side first warp thread; 5bL: left-side second warp thread; 5bR: right-side second warp thread; 6a: weft thread (first weft thread); 6b: weft thread (second weft thread); 6i: inside weft thread; 6o: outside weft thread; 6s: helical weft thread; 6L: left-side weft thread; 6R: right-side weft thread; 7: intersecting portion; 7a-7d: first-fourth intersecting portion; 7L: left-side intersecting portion; 7R: right-side intersecting portion; 8: lifting/lowering cord; 8L: left-side lifting/lowering cord; 8R: right-side lifting/lowering cord; 9: operation shaft; 10, 10a: guide ring; 30: jig; 31: insertion hole; 32: holding apparatus; 41: head box; 42: supporting member; 43: ladder cord-suspending shaft; 44: angle-adjusting shaft; 45: operation apparatus; 46: input shaft; 47: universal joint; 48: operation rod; 49: bottom rail; 50: stopper apparatus; 51: cord-equalizer; 52: slat-restricting member; R: ring; D: depth; A, W: distance; S: width; H1, H2: thickness; L: string; L1-L4: first-fourth knitting yarn

1-14. (canceled)

15. A horizontal blind comprising:
a head box;
multiple ladder cords suspended from the head box, each of the ladder cords having two warp threads and a weft provided between the two warp threads at each rung thereof;
slats each supported by the weft at each rung of the ladder cords; and
multiple lifting and lowering cords suspended from the head box, the slats being configured so as to be capable of being turned through the intermediary of the ladder cords and capable of being lifted or lowered by lifting or lowering the lifting and lowering cords,
wherein the weft at each rung of the ladder cords is formed of multiple pieces of weft threads, at least one intersecting portion is formed in the weft threads, the slat is inserted among the intersecting portion and the weft threads, and the lifting and lowering cord is inserted between the weft threads at a location between the intersecting portion and the warp thread.

16. The horizontal blind of claim 15, wherein the weft is formed of two weft threads which are formed on the warp threads in a state where they intersect with each other.

17. The horizontal blind of claim 15, wherein a notch that engages with the weft thread is provided in a side edge of the slat on a side where the lifting and lowering cord is arranged.

18. The horizontal blind of claim 15, wherein the following relationship exists:
W+(A/2)≧S
where W denotes a distance between the two warp threads, A denotes a distance between the two weft threads, and S denotes a width of the slat.

19. The horizontal blind of claim 15, wherein the following relationship exists:
H1+H2≦D
where D denotes a depth of the notch provided in one side edge of the slat, H1 denotes a thickness of the lifting and lowering cord, and H2 denotes a thickness of the weft thread.

20. The horizontal blind of claim 15, wherein the lifting and lowering cord inserted between the multiple pieces of weft threads at the location between the intersecting portion and the warp thread is inserted such that the multiple pieces of weft threads at the intersecting portion intersect with each other as seen from above.

21. The horizontal blind of claim 15, wherein the intersecting portion is formed to be one-sided to the notch of the slat.

22. The horizontal blind of claim 15, wherein the lifting and lowering cord is inserted between the weft threads every multiple rungs.

23. A method of manufacturing a horizontal blind comprising the steps of:
forming two weft threads that intersect with each other into a weft of each rung of a ladder cord;
expanding a space between an intersecting portion of the weft threads and one of warp threads of the ladder cord by means of a jig and inserting a slat in the space; and
inserting a lifting and lowering cord between the weft threads at a location between the intersecting portion of the weft threads and another of the warp threads of the ladder cord.

24. The method of manufacturing a horizontal blind of claim 23, wherein the jig is provided with multiple operation shafts corresponding one-to-one with the rungs of the ladder cord, each of the operation shafts expanding the space between the intersecting portion of the weft threads and the one of the warp threads of the ladder cord for inserting the slat in the space, and the space between the intersecting portion of the weft threads and the one of the warp threads of the ladder cord is expanded simultaneously for all rungs of the ladder cord by means of each of the operation shafts.

25. The method of manufacturing a horizontal blind of claim 23, wherein insertion of the lifting and lowering cord between the weft threads at the location between the intersecting portion of the weft threads and another of the warp threads of the ladder cord is performed such that the two weft threads intersect with each other as seen from above.

26. The method of manufacturing a horizontal blind of claim 23, wherein insertion of the lifting and lowering cord between the weft threads at the location between the intersecting portion of the weft threads and another of the warp threads of the ladder cord is performed such that the two weft threads do not intersect with each other as seen from above.

27. The method of manufacturing a horizontal blind of claim 23, wherein right-side and left-side ladder cords for supporting right and left sides of the slats, respectively, are so configured that intersecting portions that engage with notches of the slats intersect such that directions of overlap of the weft threads in right and left direction are different between the right-side and left-side ladder cords, and
insertion of the lifting and lowering cords at both right and left sides between the weft threads at the location between the intersecting portion of the weft threads and another of the warp threads of the ladder cord is performed such that the two weft threads do not intersect with each other as seen from above.

28. The method of manufacturing a horizontal blind of claim 15, wherein the intersecting portion is formed such that one of the weft threads is wound half or more around another of the weft threads and linked to the warp threads so that a state of intersection is not raveled.
